(19) United States
(12) Patent Application Publication
(10) Pub. No.: US 2016/0122132 A1
(43) Pub. Date: May 5, 2016

(54) LANE ADJUSTMENT SYSTEM

(71) Applicant: Septimatech Group Inc., Waterloo (CA)

(72) Inventors: Glen Albert Bell, Waterloo (CA); Andrew Fredrick Netherton, Waterloo (CA)

(73) Assignee: Septimatech Group Inc., Waterloo (CA)

(21) Appl. No.: 14/926,129

(22) Filed: Oct. 29, 2015

Related U.S. Application Data
(60) Provisional application No. 62/072,037, filed on Oct. 29, 2014.

(51) Int. Cl. B65G 21/20

(52) U.S. Cl. CPC B65G 21/2072

(57) ABSTRACT

A lane adjustment system for guiding containers moved by one or more conveyors in a preselected direction in one or more lanes, each lane having a lane width transverse to the preselected direction. The lane adjustment system includes a number of lane guide elements, to at least partially define the lanes respectively, and one or more lane guide adjustor modules, each secured to a selected one of the lane guide elements for moving the selected one of the lane guide elements a predetermined distance in a predetermined direction at least partially transverse to the preselected direction, to change the lane width by the predetermined distance.

This application claims the benefit of U.S. provisional patent application No. 62/072,037, filed Oct. 29, 2014, the entirety of which is hereby incorporated by reference.

### FIELD OF THE INVENTION

The present invention is a lane adjustment system for guiding containers moved by one or more conveyors in one or more lanes.

### BACKGROUND OF THE INVENTION

Conveyor systems used in manufacturing packaging goods often include guides that define lanes into which articles on a conveyor are directed. The articles may be, for instance, packaged goods or containers, e.g., bottles or other containers into which a product has been placed, or is to be placed. Depending on the circumstances, the guides forming the lanes may be used at one or more different points in the packaging process. As is well known in the art, the guides are positioned precisely relative to the conveyor, in order that the lanes are the precise optimum width for the containers. Because the conveyors typically move the containers at relatively high speed, an inaccurately positioned guide may cause the conveyors to jam, resulting in lost production.

For example, where filled bottles are to be positioned in two groups of three on each side of a carton, lanes may be configured to position filled and capped bottles into two separate lines in which the bottles are arranged in single file respectively, so that the bottles may conveniently be packaged in the cartons. In this example, once the filled bottles are in two parallel single files, they can relatively easily be positioned in the respective cartons by a packaging machine.

As is well known in the art, the positions of the guides defining the lanes typically are required to be changed from time to time, when the shapes and/or sizes of the containers are changed. Also, other parameters (e.g., the cartons or other packaging in which the filled containers are positioned) may also change from time to time, and the lane guides may need to be repositioned accordingly.

However, in the prior art, the mechanisms and methods for adjusting the positions of the guides are generally labor-intensive, and also typically are somewhat inaccurate. The lack of accuracy in positioning the guides can, and sometimes does, result in the containers that are conveyed becoming jammed, requiring that the conveyor be stopped to clear away the jammed materials.

### SUMMARY OF THE INVENTION

There is a need for a lane adjustment system that overcomes or mitigates one or more of the disadvantages or defects of the prior art. Such disadvantages or defects are not necessarily included in those listed above.

In its broad aspect, the invention provides a lane adjustment system for guiding containers moved by one or more conveyors in a preselected direction in one or more lanes having a lane width transverse to the preselected direction. The lane adjustment system includes a number of lane guide elements, to at least partially define the lanes, and one or more lane guide adjustor modules secured to respective selected ones of the lane guide elements for moving the selected one of the lane guide elements a predetermined distance in a predetermined direction that is at least partially transverse to the preselected direction, to change the lane width by the predetermined distance.

In another of its aspects, the invention provides a lane adjustment system for guiding containers moved by one or more conveyors in a preselected direction in one or more lanes on the conveyor that has a lane width transverse to the preselected direction. The lane adjustment system includes a number of lane guide elements, to at least partially define the lanes, and a number of cross-members positioned at least partially transverse to the preselected direction and positioned spaced apart from each other along the conveyor(s). The lane adjustment system also includes one or more lane guide adjustor modules secured to a selected one of the lane guide elements and mounted to a selected one of the cross-members. The lane adjustor module includes a drive subassembly for moving the selected one of the guide elements a predetermined distance along the selected one of the cross-members, to change the lane width by the predetermined distance. In addition, the lane adjustment system includes a drive element secured to the drive subassembly and rotatable thereby about a drive element axis of rotation in direct relation to movement of the lane guide adjustor module over the predetermined distance along the selected one of the cross-members. Also, the lane adjustment system also includes one or more lane guide support modules mounted on a selected support one of the cross-members, having a support subassembly engaged with the selected support one of the cross-members and secured to the drive element. The lane guide support module is secured to the selected one of the lane guide elements. The support subassembly is formed to convert rotational motion of the drive element to linear motion of the lane guide support module over the predetermined distance along the selected support one of the cross-members, to change the lane width by the predetermined distance.

### BRIEF DESCRIPTION OF THE DRAWINGS

The invention will be better understood with reference to the attached drawings, in which:

FIG. 1A is an isometric view of an embodiment of a lane adjustment system of the invention including a funnel lane adjustment subsystem, a straight lane adjustment subsystem, a corner lane adjustment subsystem, and a transition lane adjustment subsystem;

FIG. 1B is an isometric view of the funnel lane adjustment subsystem and the straight lane subsystem of FIG. 1A, drawn at a larger scale;

FIG. 1C is a top view of the straight lane subsystem of FIG. 1B;

FIG. 1D is a portion of the straight lane subsystem of FIG. 1C, drawn at a larger scale;

FIG. 1E is the portion of the straight lane subsystem of FIG. 1D, with drive elements omitted;

FIG. 2A is an isometric view of an alternative embodiment of the straight lane adjustment subsystem of the invention, drawn at a smaller scale;

FIG. 2B is an isometric view of an embodiment of an lane guide adjustor module of the invention, drawn at a larger scale;

FIG. 2C is an isometric view of lane guide adjustor modules mounted on an embodiment of a cross-member of the invention, drawn at a smaller scale;

FIG. 2D is an isometric view of the lane guide adjustor modules of FIG. 2C in which certain elements of one of the lane guide adjustor modules are viewable;

FIG. 2E is an isometric view of the lane guide adjustor modules of FIGS. 2C and 1D in which further elements of one of the lane guide adjustor modules are viewable;

FIG. 2F is another isometric view of the lane guide adjustor modules of FIG. 2E;

FIG. 2G is another isometric view of the lane guide adjustor modules of FIG. 2F in which further elements of another lane guide adjustor module are viewable;

FIG. 2H is another isometric view of the lane guide adjustor modules of FIG. 2G in which further elements of another lane guide adjustor module are viewable;

FIG. 2I is an isometric view of an embodiment of a lane guide support module of the invention, drawn at a larger scale;

FIG. 2J is an isometric view of the lane guide support module of FIG. 2I in which further elements thereof are viewable, drawn at a smaller scale;

FIG. 3A is an isometric view of an alternative embodiment of a lane guide adjustor module of the invention, drawn at a larger scale;

FIG. 3B is an isometric view of the lane guide adjustor module of FIG. 3A, with certain parts thereof removed;

FIG. 4A is a front view of an embodiment of the lane guide support module of the invention, drawn at a larger scale;

FIG. 4B is a side view of the lane guide support module of FIG. 4A;

FIG. 4C is a back view of the lane guide support module of FIGS. 4A and 4B;

FIG. 4D is an isometric view of the lane guide support module of FIGS. 4A-4C, with certain parts thereof removed, drawn at a larger scale;

FIG. 5A is a top view of a portion of the funnel lane adjustment subsystem of FIGS. 1A and 1B;

FIG. 5B is a top view of another portion of the funnel lane adjustment subsystem of FIG. 5A;

FIG. 5C is a top view of portions of the funnel lane adjustment subsystem of FIGS. 5A and 5B and the straight lane adjustment subsystem of FIGS. 1A and 1B;

FIG. 5D is an isometric view of a portion of the funnel lane adjustment subsystem of FIG. 5A in which certain parts of a lane adjustment module are omitted, drawn at a larger scale;

FIG. 6A is a top view of the corner lane adjustment subsystem of FIG. 1A, drawn at a smaller scale;

FIG. 6B is a top view of a portion of the corner lane adjustment subsystem of FIG. 6A, drawn at a larger scale;

FIG. 6C is a top view of the corner lane adjustment subsystem of FIGS. 6A and 6B with certain elements omitted, drawn at a smaller scale;

FIG. 6D is an isometric view of the corner lane adjustment subsystem of FIG. 6A;

FIG. 7A is a top view of the transition lane adjustment subsystem of FIG. 1A, drawn at a smaller scale;

FIG. 7B is an isometric view of the transition lane adjustment subsystem of FIG. 7A;

FIG. 8A is an isometric view of an alternative embodiment of the lane guide support module of the invention mounted on an alternative embodiment of the cross-member of the invention, drawn at a larger scale;

FIG. 8B is a side view of the lane guide support module and cross-member of FIG. 8A, drawn at a larger scale;

FIG. 9A is an isometric view of another alternative embodiment of the lane guide support module of the invention mounted on an alternative embodiment of the cross-member of the invention, drawn at a smaller scale; and

FIG. 9B is a side view of the lane guide support module and cross-member of FIG. 9A, drawn at a larger scale.

### DETAILED DESCRIPTION

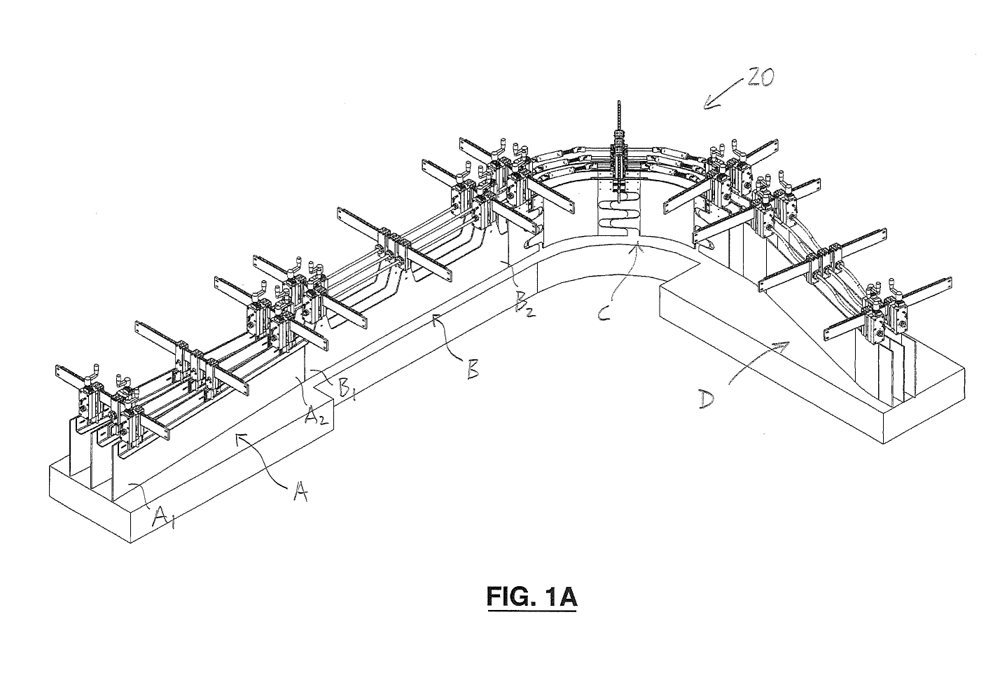

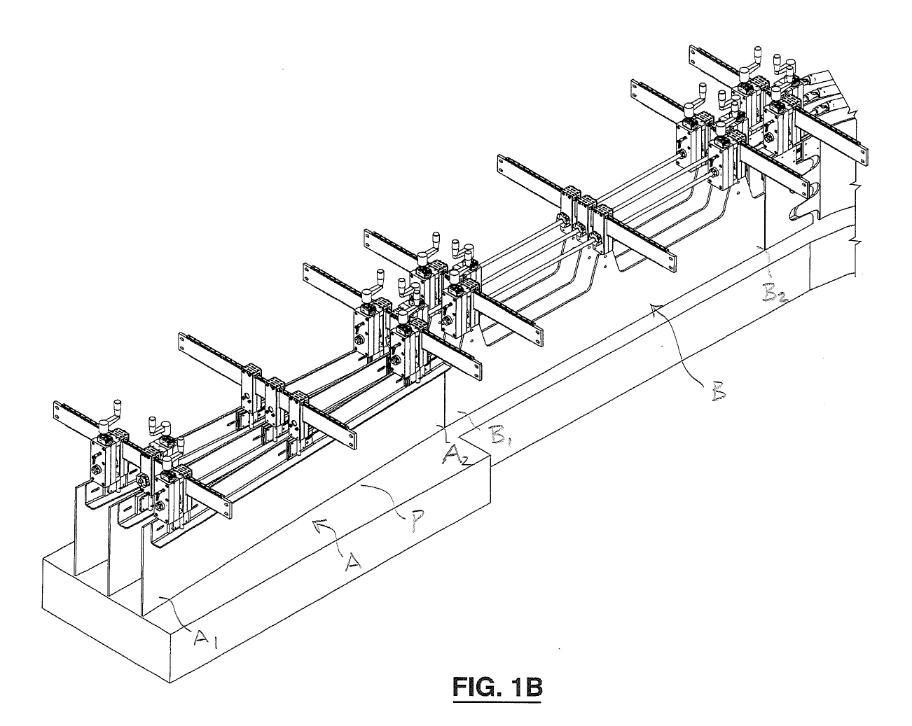

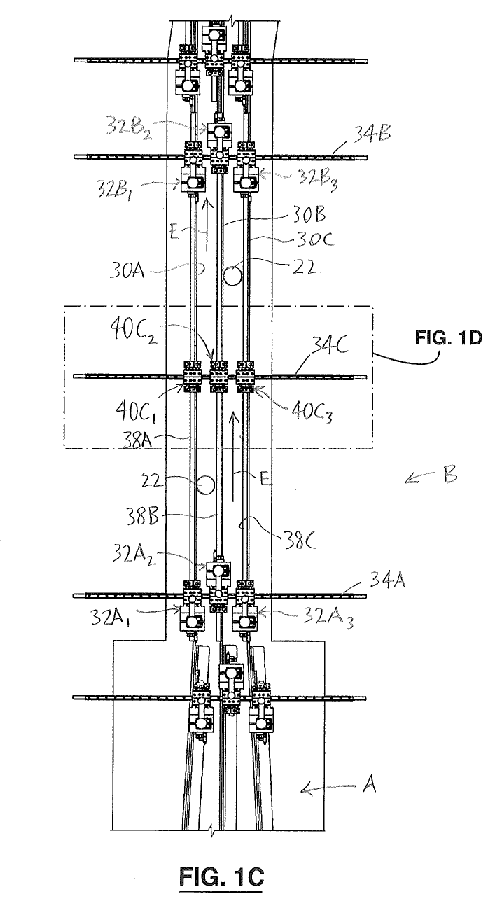

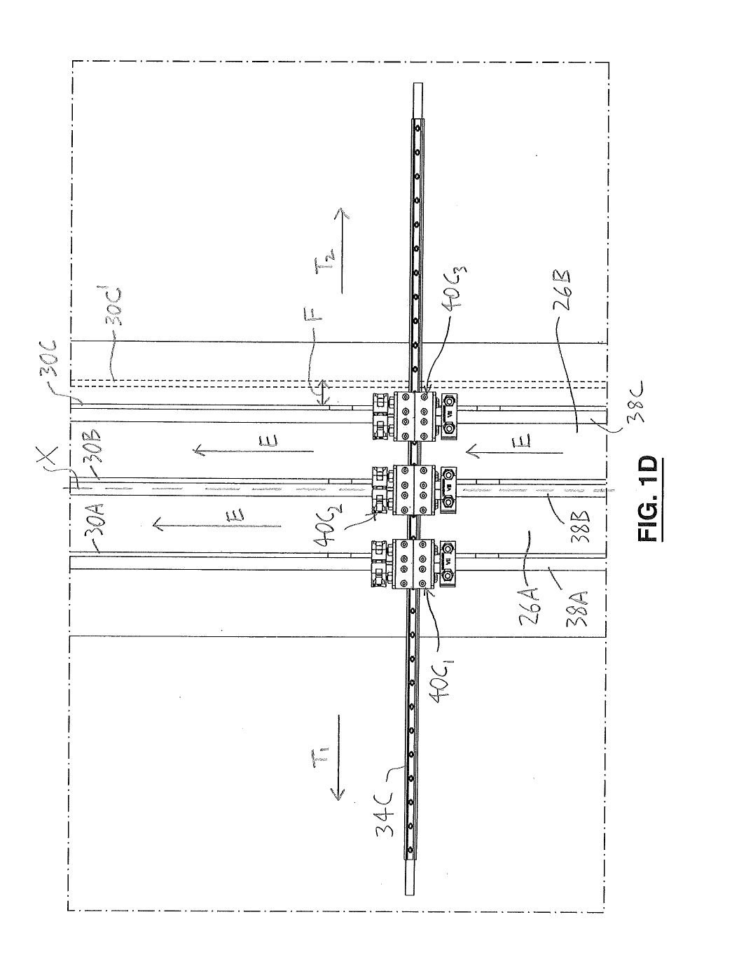

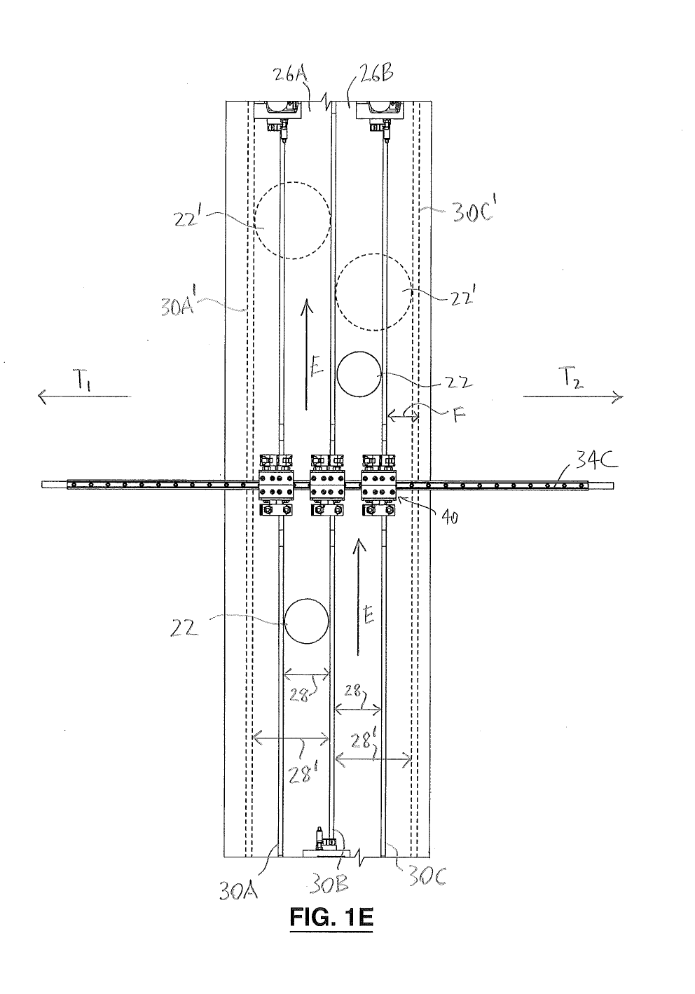

In the attached drawings, like reference numerals designate corresponding elements throughout. Reference is made to FIGS. 1A-7B to describe an embodiment of a lane adjustment system in accordance with the invention indicated generally by the numeral 20. As can be seen in FIG. 1A, in one embodiment, the lane adjustment system 20 preferably includes a funnel lane adjustment subsystem “A”, a straight lane adjustment subsystem “B”, a corner lane adjustment subsystem “C”, and a transition lane adjustment subsystem “D”.

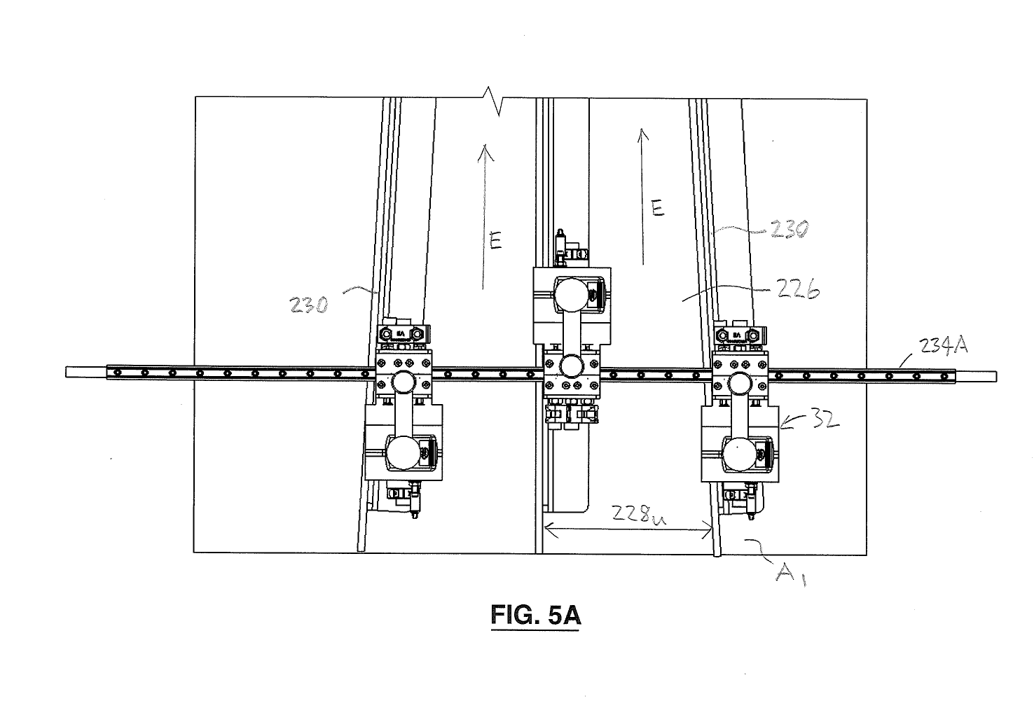

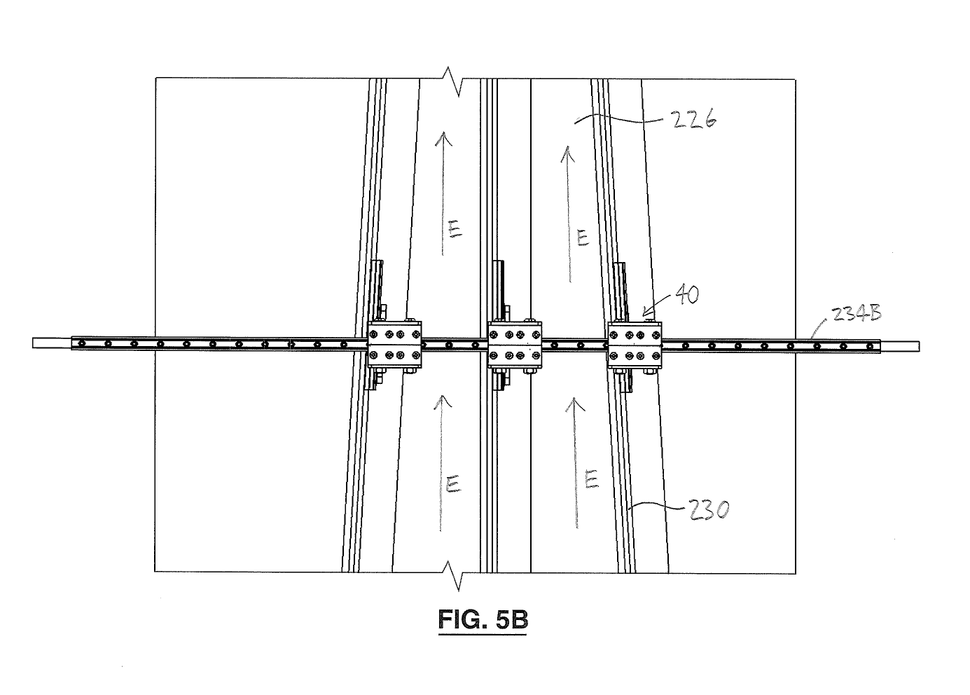

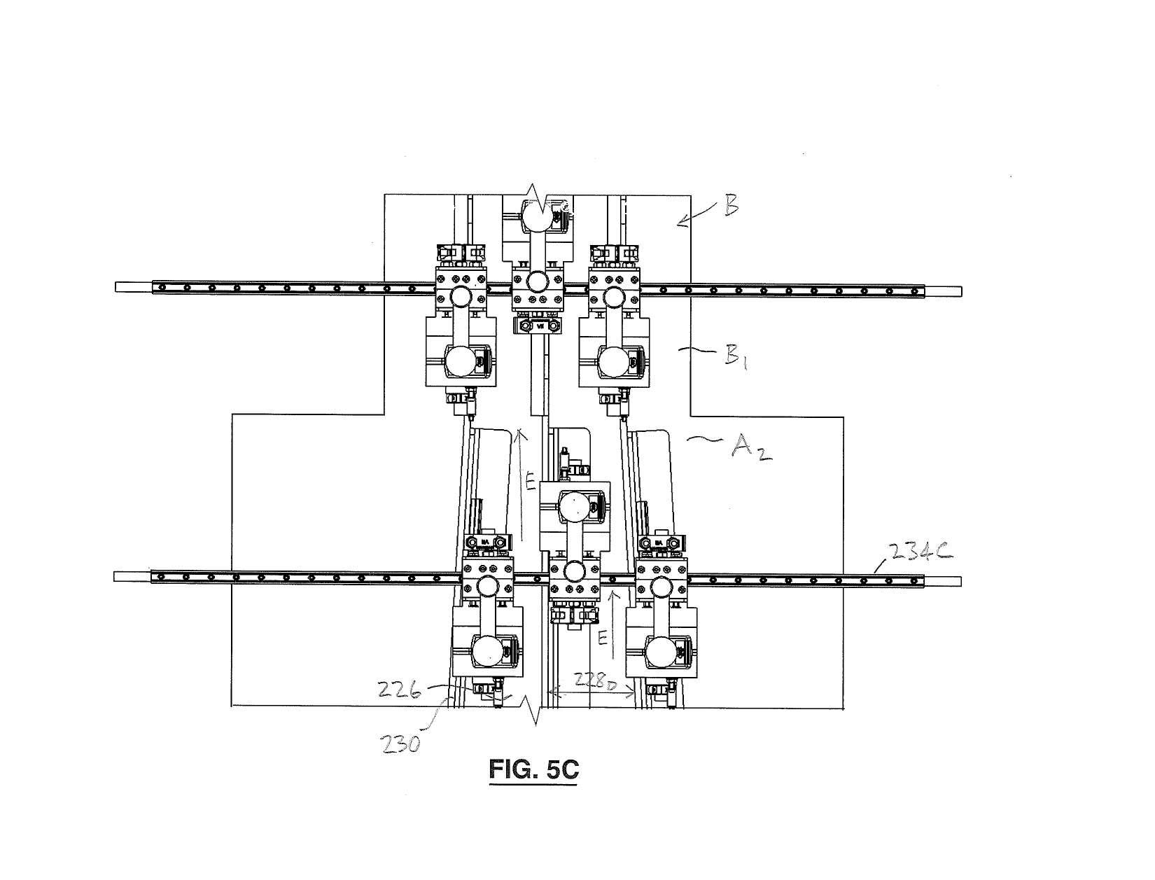

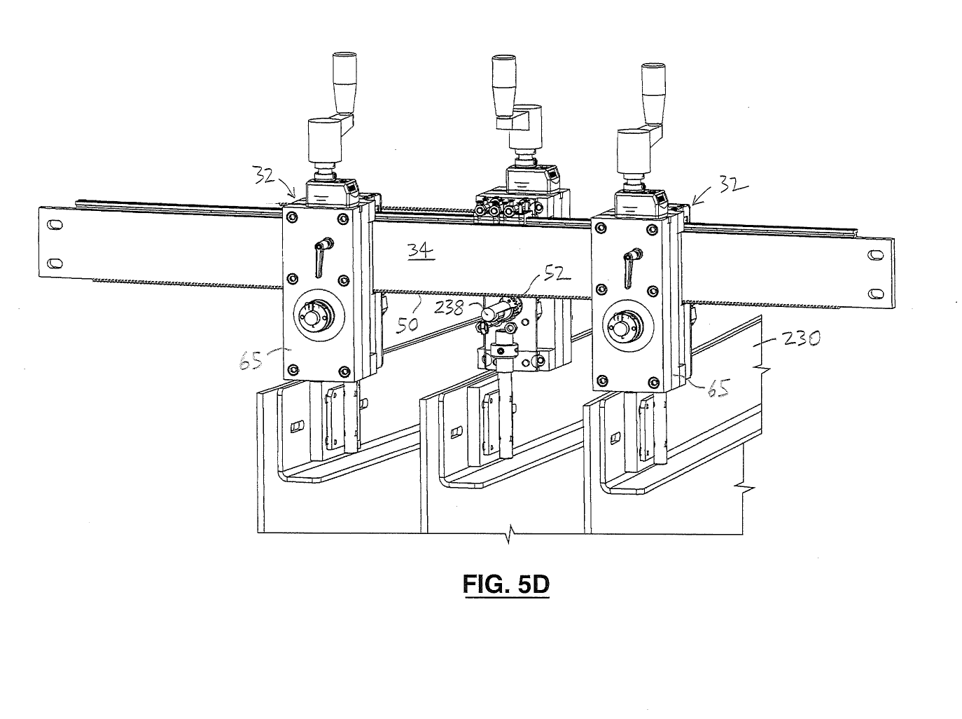

The lane adjustment system 20 is for guiding containers 22 moved by one or more conveyors 24 in a preselected direction in one or more lanes 26 having a lane width 28 transverse to the preselected direction (FIGS. 1C, 1D). The preselected direction is indicated, for instance, by arrow “E” in FIGS. 1C, 1D, 1E, and 5A. (It will be understood that, in the subsystem “B”, the preselected direction may alternatively be in the direction opposite to that indicated by the arrow “E”.) The lane adjustment system 20 preferably includes a number of lane guide elements 30, to at least partially define the lane(s) 26, and one or more lane guide adjustor modules 32 secured to a selected one of the lane guide elements 30. As will be described, each of the lane guide adjustor modules 32 is for moving the selected one of the guide elements 32 a predetermined distance “F” (FIGS. 1D, 1E) in a predetermined direction that is at least partially transverse to the preselected direction, to change the lane width 28 by the predetermined distance “F”.

It is preferred that the predetermined direction is selected from the group consisting of a first direction “T₁” and a second direction “T₂” opposite to the first direction “T₁” that is at least partially transverse relative to the preselected direction (FIGS. 1D, 1E).

In one embodiment, the lane adjustment system 20 preferably also includes a number of cross-members 34 positioned at least partially transverse to the preselected direction and spaced apart from each other along the conveyor 24. It is also preferred that each of the lane guide adjustor modules 32 is mounted on a selected one of the cross-members 34, as will be described. Preferably, each of the lane guide adjustor modules 32 includes a drive subassembly 36. The drive subassembly 36 preferably engages the selected one of the cross-members 34 (i.e., the cross-member 34 on which the lane guide adjustor module 32 that includes the drive subassembly 36 is mounted) to move the lane guide adjustor module 32 the predetermined distance “F” in the predetermined direction relative to the conveyor 24.

It will be understood that the cross-members 34 are supported and secured in their respective positions by support elements and brackets (not shown in FIGS. 1A-1E). For instance, each cross-member may be supported at its respective ends by support elements that are secured to the conveyor, or to a floor. The support elements and brackets are omitted from FIGS. 1A-1E for clarity of illustration.

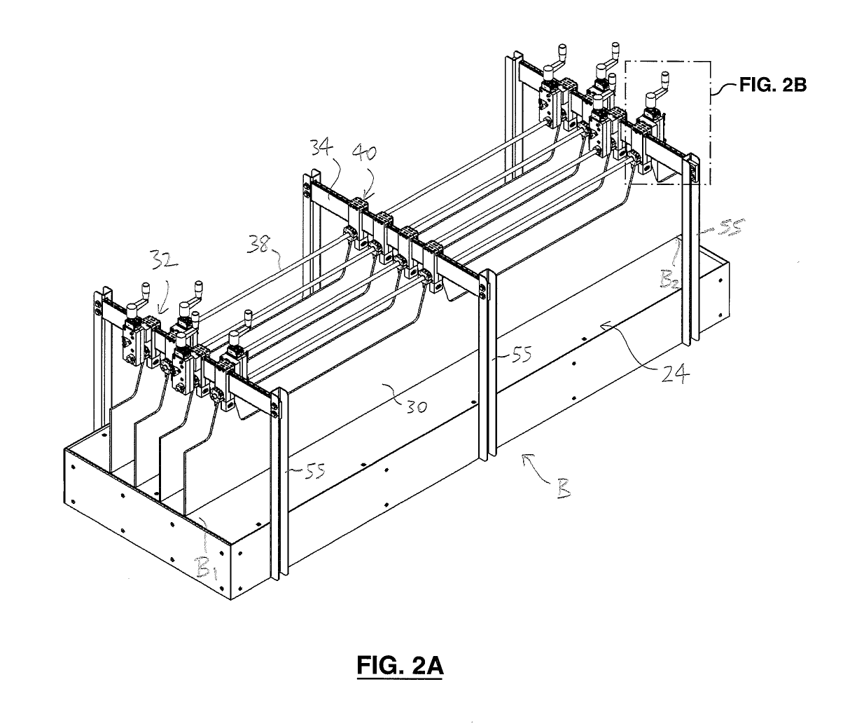

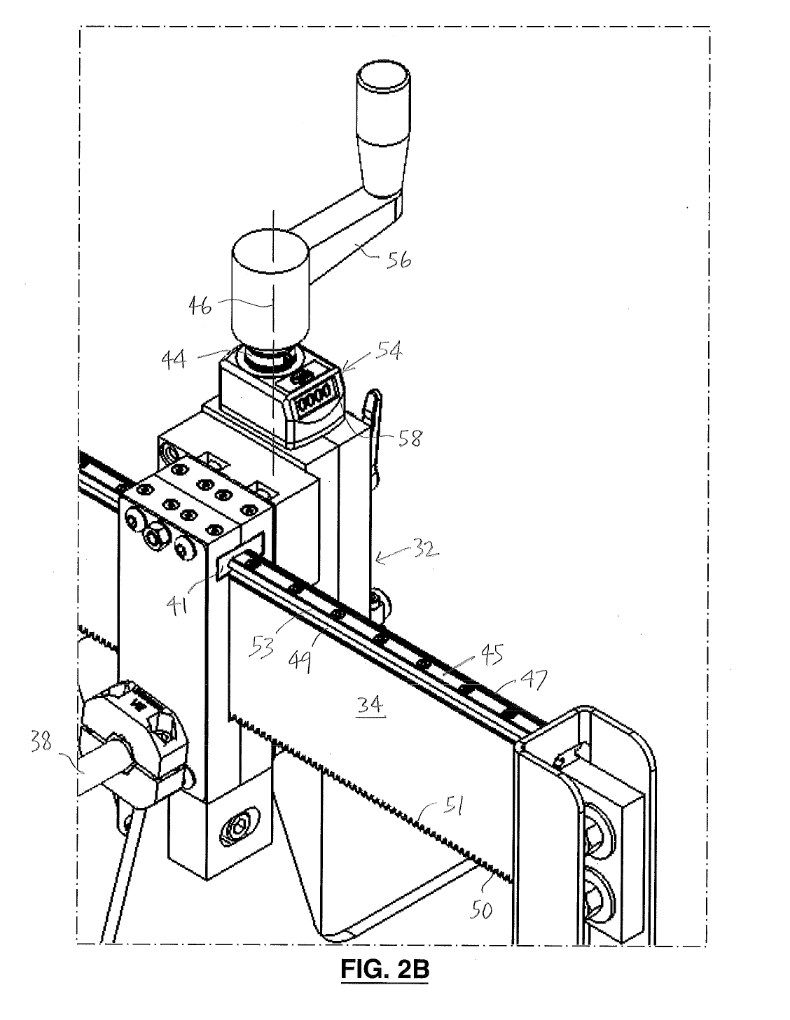

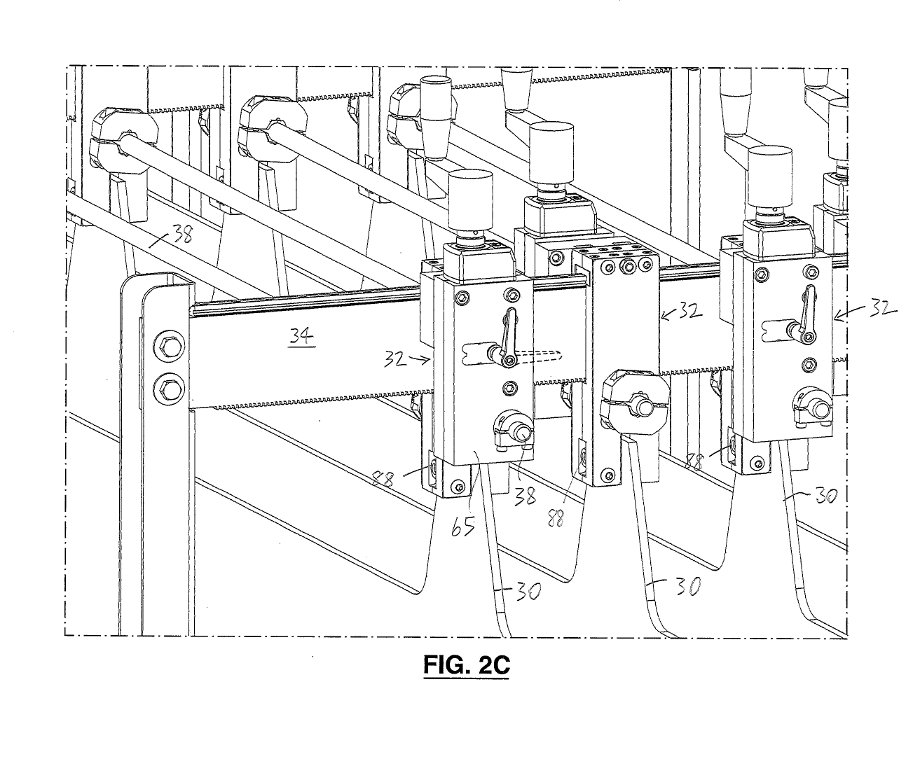

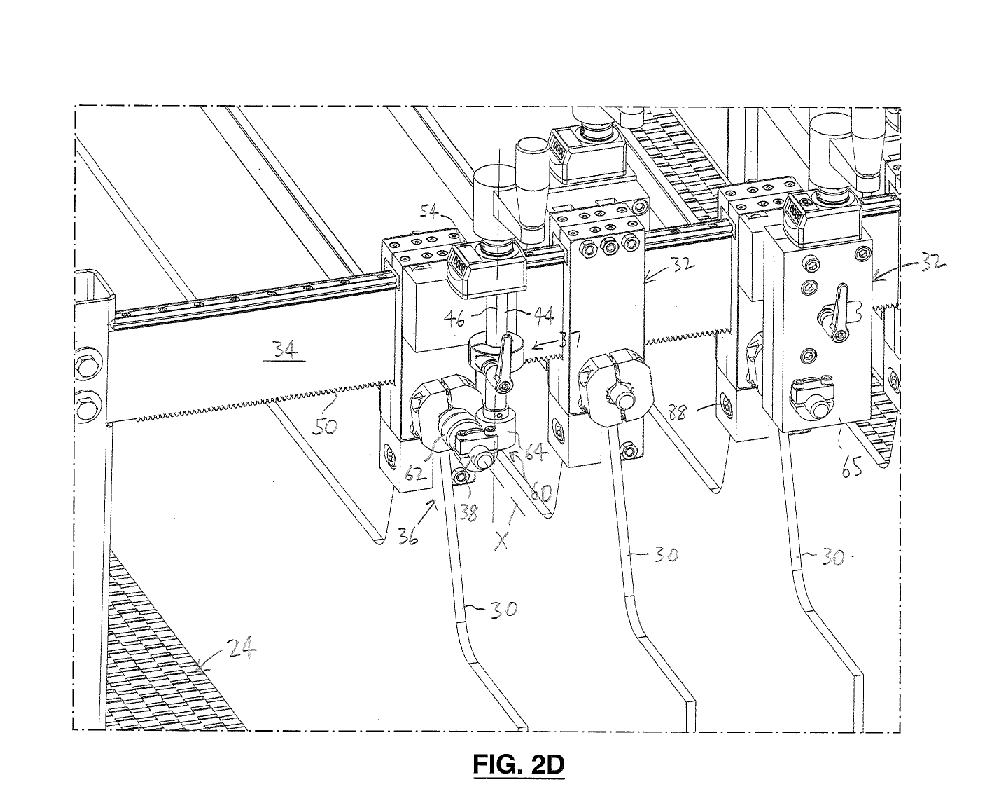

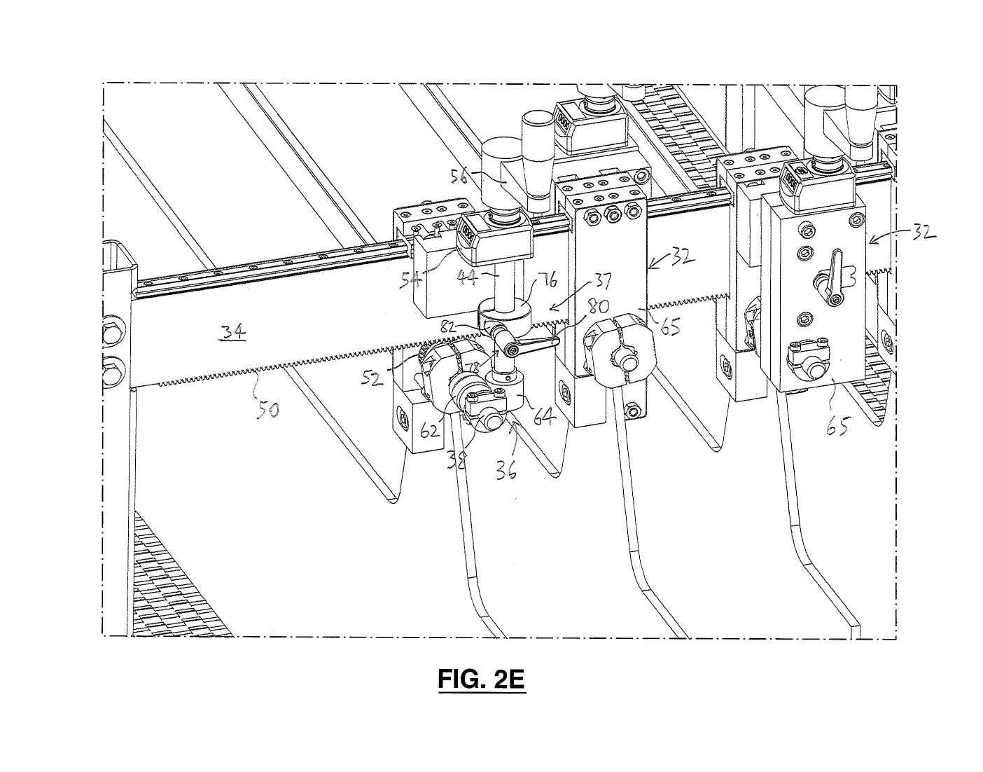

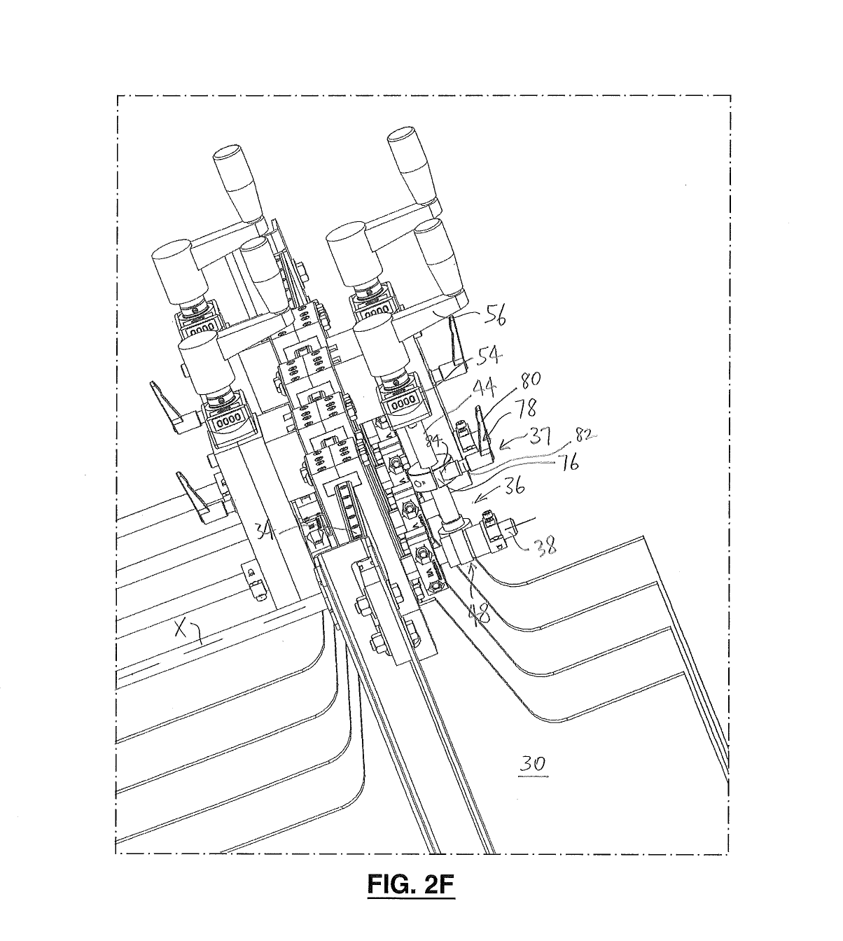

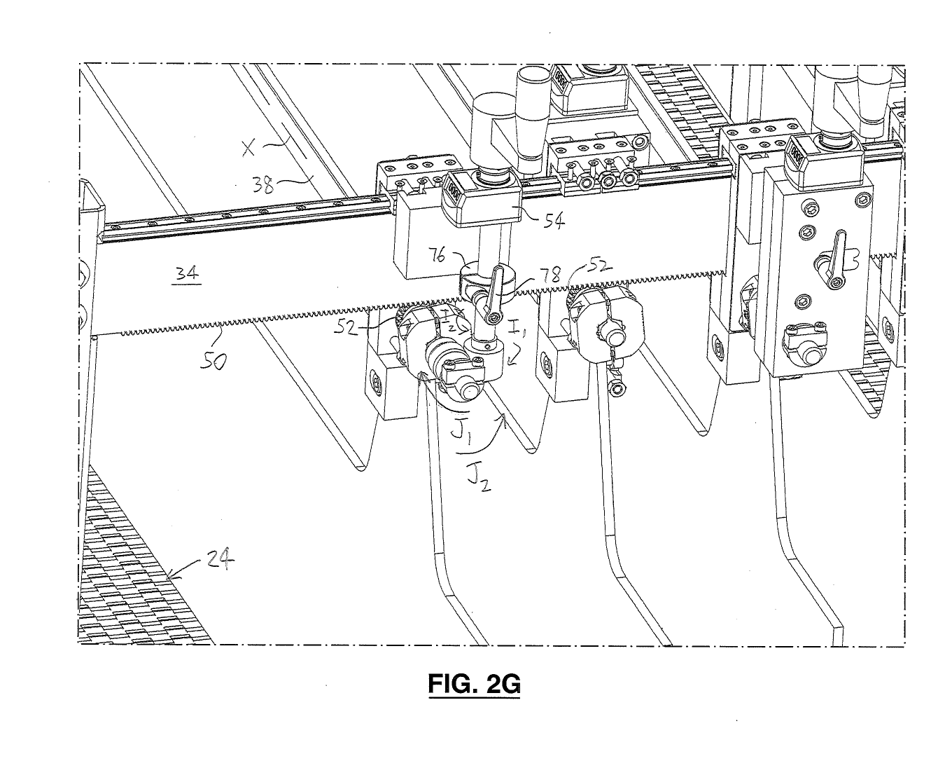

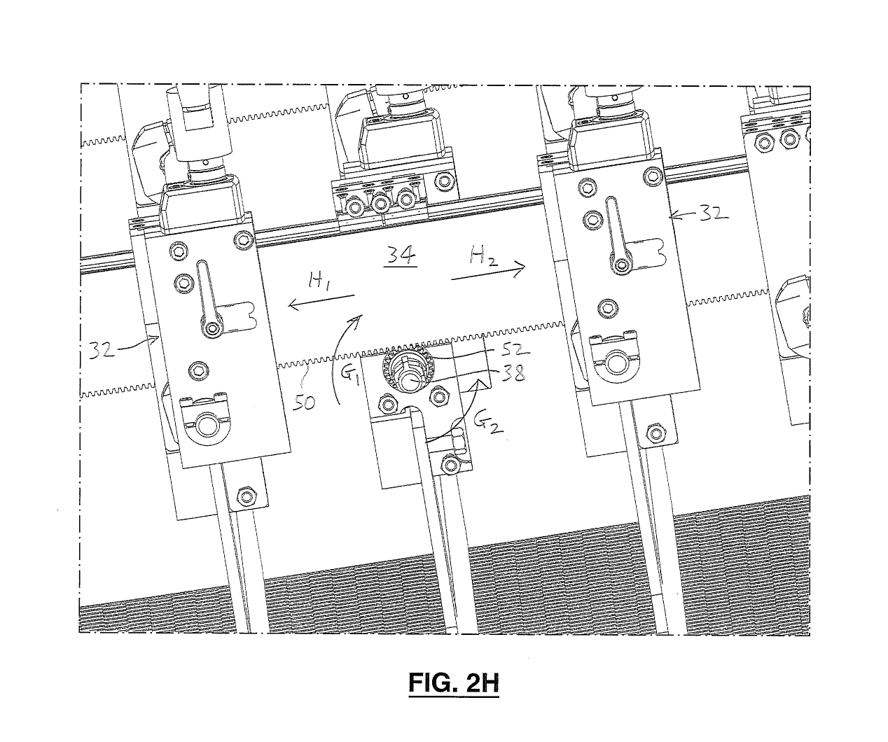

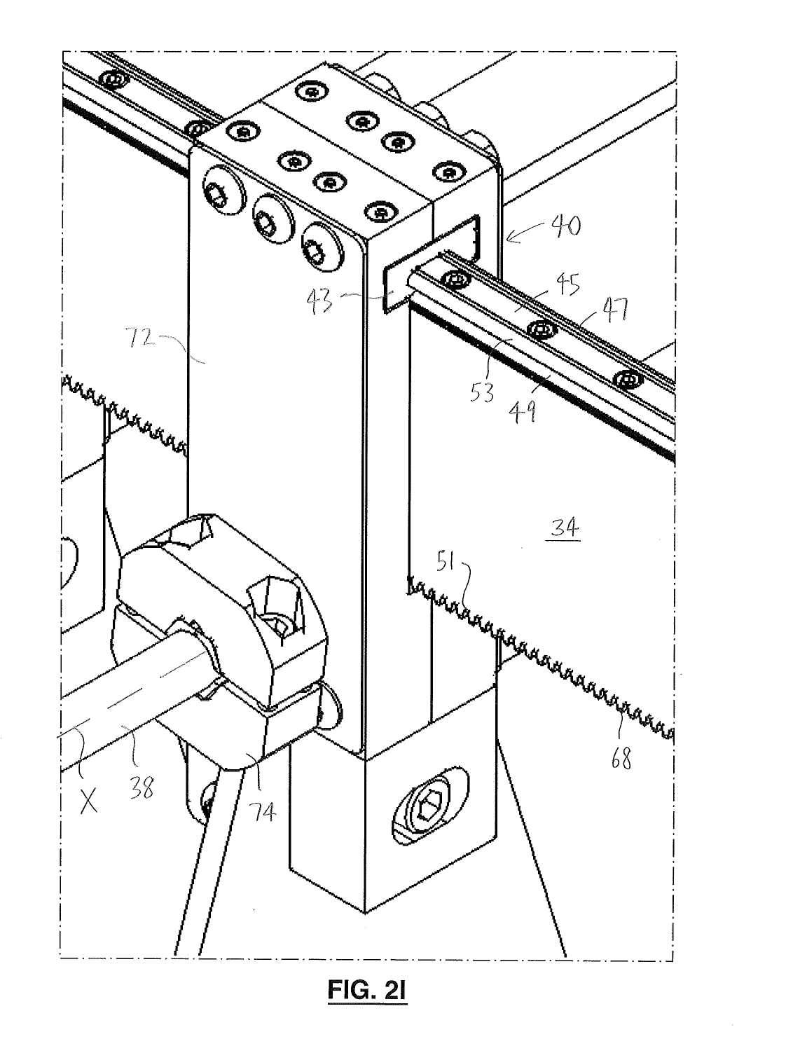

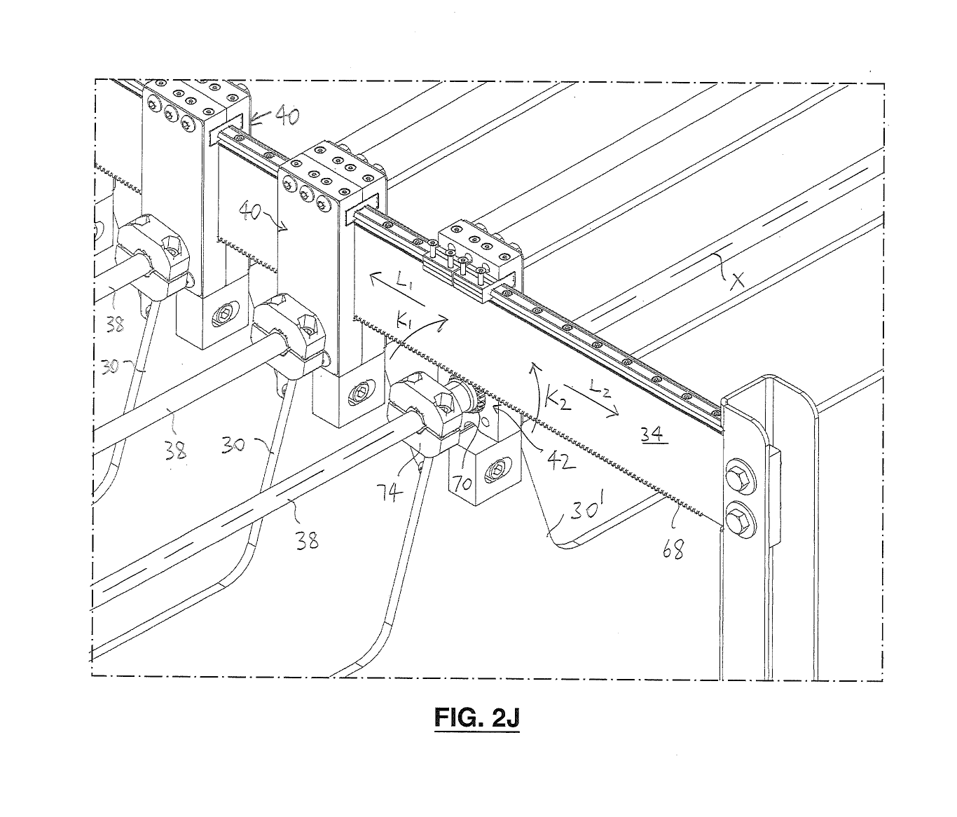

In an alternative embodiment, the lane guide adjustor module 32 preferably additionally includes a lock subassembly 37 movable between a locked condition, in which the lane guide adjustor module 32 is held stationary thereby relative to the selected one of the cross-members 34, and an unlocked condition, in which the lane guide adjustor module 32 is movable in the predetermined direction relative to the selected one of the cross-members (FIG. 2D). As will be described, the lock subassembly 37 is for securing the lane guide adjustor module 32 in a desired position, i.e., once the lane guide adjustor module 32 has been moved by the predetermined distance “F” in the predetermined direction to the desired position.

As can be seen, for example, in FIGS. 1C and 1D, it is also preferred that the lane adjustment system 20 preferably also includes one or more elongate drive elements 38, each being at least partially defined by an axis of rotation “X” thereof (FIG. 1D). Preferably, the drive element 38 is secured to the drive subassembly 36 of each lane guide adjustor module 32 respectively, for rotation of the drive element 38 by the drive subassembly 36 corresponding to movement of the lane adjustment module 32 in the predetermined direction relative to the selected one of the cross-members 34.

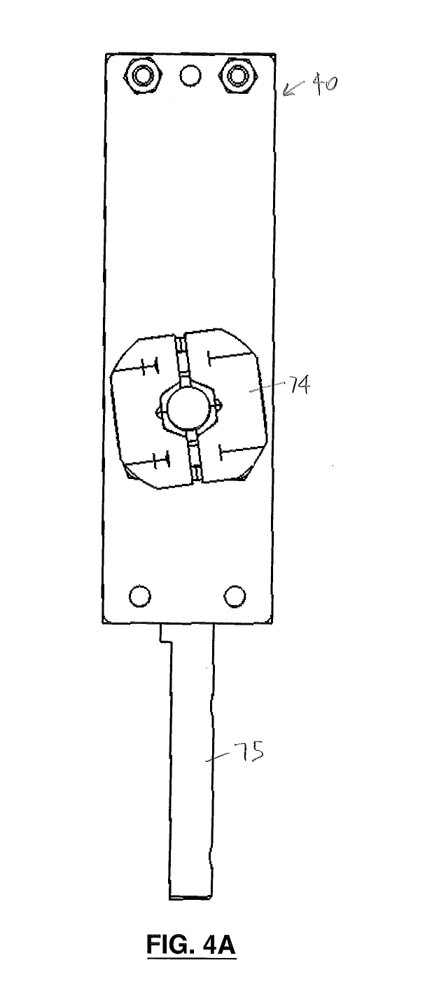

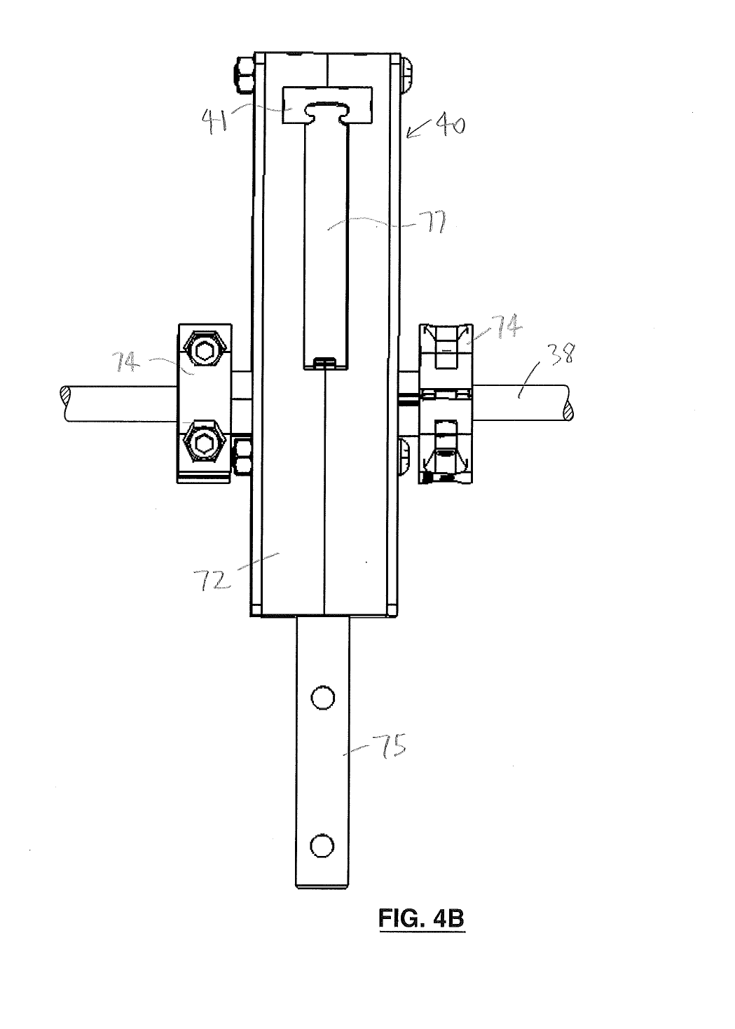

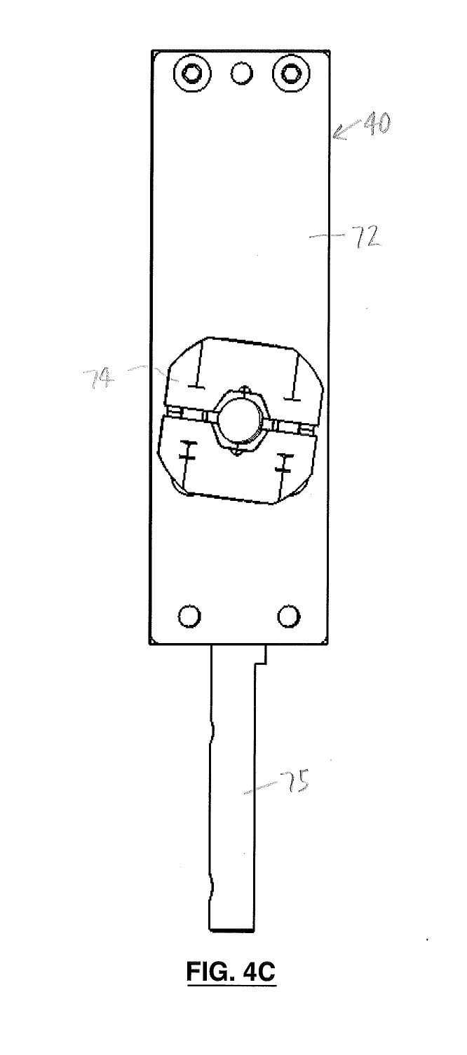

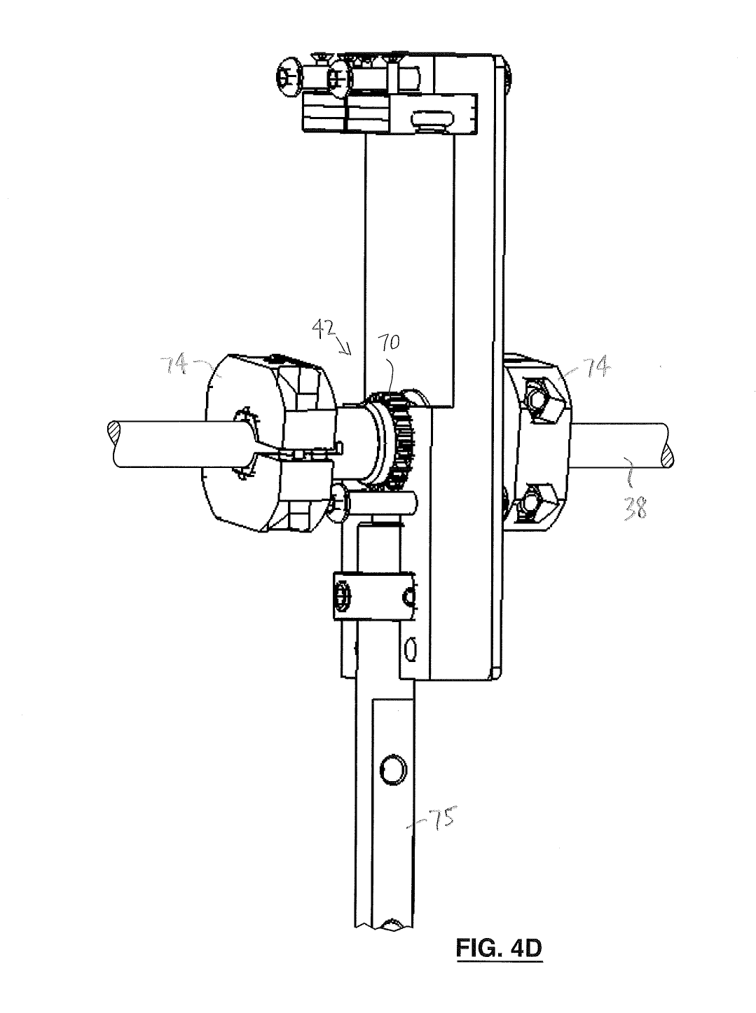

In one embodiment, the lane adjustment system 20 preferably includes one or more lane guide support modules 40 mounted to a selected support one of the cross-members 34 (FIG. 2I). Preferably, the lane guide support module 40 is also secured to the selected one of the lane guide elements 30. It is also preferred that the lane guide support module 40 includes a support subassembly 42 (FIGS. 2J, 4D). Preferably, the support subassembly 42 is secured to the drive element 38, as will be described. As will also be described, the support subassembly 42 preferably engages the selected support one of the cross-members 34 for converting rotation of the drive element 38 to linear motion of the lane guide support module 32 over the predetermined distance “F” along the selected support one of the cross-members 34 relative to the conveyor 24, to change the lane width 28 by the predetermined distance “F”.

As can be seen in FIG. 1C, the straight lane adjustment subsystem “B” includes a number of the cross-members 34. In the arrangement illustrated, two lanes are defined by three lane guide elements. For convenience, the lane guide elements illustrated in FIG. 1C-1E are identified therein as 30A, 30B, and 30C, and the two lanes at least partially defined thereby are identified as 26A and 26B respectively.

It will be understood that, as illustrated in FIGS. 1C and 1D, the three lane guide elements 30A-30C are located partially below the drive elements 38A, 38B, 38C respectively, i.e., the three lane guide elements 30A-30C are partially obscured by the three drive elements 38A-38C respectively, in FIGS. 1C and 1D. In FIG. 1E, the drive elements are omitted, so that the lane guide elements 30A-30C may be clearly shown therein.

In FIG. 1C, it can also be seen that a number of the lane guide adjustor modules 32 are mounted on the selected one of the cross-members that is identified for convenience by reference numeral 34A. Those lane guide adjustor modules are identified in FIG. 1C by reference numerals 32A₁-32A₃ respectively for convenience. Similarly, a second group of lane guide adjustor modules 32 is also mounted to a second cross-member, identified for convenience by reference numeral 34B. Those lane guide adjustor modules are identified in FIG. 1C by reference numerals 32B₁-32B₃ respectively for convenience. The two groups of lane guide adjustor modules 32, positioned on the cross-members 34A, 34B respectively, are located at respective upstream and downstream ends “B₁”, “B₂” of the straight lane adjustment subsystem “B” (FIGS. 1A, 1B).

The selected support one of the cross-members is identified for convenience by reference numeral 34C. In the example illustrated in FIGS. 1A-1E, a group of three lane guide support modules 40 is mounted on the cross-member 34C. Those lane guide support modules are identified in FIG. 1C by reference numerals 40C₁-40C₃ respectively for convenience. The cross-member 34C preferably is located substantially equidistant from each of the cross-members 34A, 34B.

In FIGS. 1C-1E, the lane guide adjustor modules 32A₁-32A₃ and 32B₁-32B₃ are secured to the three lane guide elements respectively that are identified for convenience by reference numerals 30A-30C. As illustrated in FIG. 1E, the lane guide elements 30A, 30B define the lane 26A between them. Also, the lane guide elements 30B, 30C define the lane 26B between them. Each of the lanes 26A, 26B preferably has the same lane width 28 thereof (FIG. 1E). In addition, the lane guide support modules 40C₁-40C₃ are also secured to the lane guide elements 30A-30C respectively. Also, the drive elements extending between the lane guide adjustor modules 32A₁-32A₃ and 32B₁-32B₃ respectively are identified by reference numerals 38A, 38B, and 38C for convenience.

In FIGS. 1D and 1E, transverse movement of the lane guide elements 30 relative to the preselected direction is illustrated. The manner in which the changes in lane width are effected can be seen in FIG. 1E. The position of the lane guide element 30C after its transverse movement by the predetermined distance “F” in the predetermined direction indicated by arrow “T₂” is shown by the lane guide element drawn in dashed lines and identified in FIGS. 1D and 1E by reference numeral 30C′, as illustrated in FIGS. 1D and 1E. A wider lane is defined between the lane guide elements 30B, 30C′, and has the lane width 28′ (FIG. 1E).

As illustrated in FIG. 1E, the lane guide element 30A is transversely movable by the predetermined distance “F” in the predetermined direction indicated by arrow “T₁” to define the new lane width 28′. The lane guide element 30A in position after this transverse movement is illustrated in dashed lines and identified in FIG. 1E by the reference numeral 30A′. (It will be understood that the adjustment of the lane guide element 30A is omitted from FIG. 1D for clarity of illustration.)

It will be understood that certain other elements (e.g., the lane guide support modules connected to the lane guide elements 30A′ and 30C′ respectively, i.e., after their respective transverse movements) are also omitted from FIGS. 1D and 1E, for clarity of illustration.

As can be seen in FIG. 1E, the lanes 26A, 26B have lane widths 28 that are suitable for guiding the containers 22. However, in the example illustrated in FIG. 1E, the lane guide elements 30A, 30B are transversely moved, relative to the preselected direction, to define lanes that accommodate larger containers 22′, outlined in dashed lines in FIG. 1E. In the example illustrated in FIG. 1E, the newly-formed lanes each have the same lane width, identified for convenience by reference numeral 28′, after the lane guide elements 30A, 30C have been repositioned. However, those skilled in the art would appreciate that the transverse movement of the lane guide elements may not necessarily be by the same distance in each case. Also, it will be understood that the lane widths may need to be narrowed, rather than widened, e.g., to accommodate changes in the containers moved by the conveyor 24. From the foregoing, and from FIGS. 1D and 1E, it can be seen how the lane widths may be changed, e.g., in order to accommodate containers of different sizes.

Those skilled in the art would also appreciate that the arrangement of the elements as illustrated in FIGS. 1A-1E is exemplary only. For instance, the number of lane guide elements required depends on the number of lanes that are specified for a particular installation, which is dependent on a number of parameters, as would be appreciated by those skilled in the art. The locations of the groups of lane guide adjustor modules 32 and the lane support adjustor modules 40 are also dependent on the requirements of a particular installation. The number of, and spacing between, the lane guide adjustor modules 32 and the lane guide support modules 40 can vary widely, depending on the requirements that a particular installation of the system is to meet.

As noted above, the lane guide elements 30 preferably are moved in the predetermined directions therefor by the lane guide adjustor modules 32. The movements of the lane guide elements 30 in the predetermined direction preferably are also controlled by the lane guide support modules 40. Preferably, the support subassembly 42 of the lane guide support module 40 is driven by the rotating drive element 38 to move the selected one of the lane guide elements 30 that is attached to the respective lane guide support modules 40 by the predetermined distance “F”, in the predetermined direction, i.e., either in the direction indicated by arrow “T₁”, or in the direction indicated by arrow “T₂” (FIG. 1E). As will be described, the support subassembly 42 preferably converts the rotational movement of the drive element 38 into transverse movement of the lane guide support module 40 relative to the preselected direction, along the cross-member 34.

Because each of the lane guide support modules 40 is secured to one of the lane guide elements 30, transverse movement of the lane guide support module 40 results in corresponding movement of the lane guide element attached to it. It is also preferred that the rotation of the drive element 38 is initiated via the drive subassembly 36 of the lane guide adjustor module 32. As described above, each of the lane guide elements 30 preferably is secured to one or more lane guide adjustor modules 32 and one or more lane guide support modules 40, so that each lane guide element 30 is moved by the predetermined distance “F”.

It will be understood that the lane adjustment system 20 and each of the lane adjustment subsystems “A”-“D” thereof may have any suitable length. It is believed that, as a practical matter, the optimum maximum length in the straight lane adjustment subsystem “B” appears to be between about 20 and about 30 feet. It is also believed that the lane guide support modules 40 connected to a particular one of the drive elements 38 are optimally positioned about four feet along the lane guide element apart from each other and/or from the closest lane guide adjustor modules 32. Those skilled in the art would appreciate that the optimal design ultimately is influenced by a number of factors, including the cost of various components. For instance, although only one intermediate cross-member 34 is illustrated in FIG. 1B between the two cross-members at the upstream and downstream ends “B₁”, “B₂” of the straight lane adjustment subsystem “B”, it will be understood that a number of lane guide support modules 40 may be connected to a particular drive element 38 and positioned in series between the upstream and downstream ends.

The drive subassembly 36 is illustrated in FIGS. 2D and 2E. As noted above, the drive subassembly 36 preferably positions the lane guide element 30 precisely in relation to the conveyor 24, to minimize the possibility of the containers 22 jamming together on the conveyor 24. In one embodiment, the drive subassembly 36 preferably includes a rod 44 rotatable about a rod axis 46 thereof (FIG. 2B) and connected to a drive gear train 48 of the drive subassembly 36, for rotation of the drive element 38 about the axis of rotation “X” thereof upon rotation of the rod 44 about the rod axis 46 (FIG. 2D).

Those skilled in the art would appreciate that the drive gear train 48 may have any suitable configuration. Embodiments of the drive gear train 48 are further described below.

Preferably, the selected one of the cross-members 34 (i.e., the cross-member 34 on which the lane guide adjustor module 32 is mounted) includes a rack 50 extending along at least a portion of the cross-member 34 (FIG. 2E). It is also preferred that the drive subassembly 36 includes a pinion gear 52 coaxial with and secured to the drive element 38 and meshably engaged with the rack 50, for linear motion of the lane guide adjustor module 32 along the selected one of the cross-members 34 upon rotation of the drive element 38. As can be seen in FIG. 2H, rotation of the drive element 38 about its axis “X” in the direction indicated by arrow “G₁” causes the teeth of the pinion gear 52 to push against the meshably engaged teeth of the rack 50, resulting in transverse movement of the lane guide adjustor module 32 along the cross-member 34 in the direction indicated by the arrow “H₁”. Similarly, rotation of the drive element 38 in the direction indicated by arrow “G₂” causes the teeth of the pinion gear 52 to push against the meshably engaged teeth of the rack 50 in the other direction, to transversely move the lane guide adjustor module 32 along the cross-member 34 in the direction indicated by arrow “H₂” (FIG. 2H). Accordingly, rotation of the rod 44 about its axis 46 results in corresponding transverse movement of the lane guide adjustor module 32 along the cross-member 34 on which it is mounted.

Those skilled in the art would appreciate that various alternative mechanisms may be used to effect controlled transverse movement of the lane guide adjustor module 32, and the lane guide element(s) 30 to which the lane guide adjustor module 32 is attached. For instance, instead of the rack-and-pinion mechanism described above, a lead screw mechanism, or a worm drive, may be used.

It is also preferred that the lane adjustment system 20 additionally includes a counter 54 operably connected with the rod 44, to count rotations of the rod 44 about the rod axis 46 (FIG. 2B). Those skilled in the art would be aware of suitable counters. The counter 54 enables an operator (not shown) to precisely position the lane guide element 30 in relation to the conveyor 24.

As can be seen in FIG. 2B, for instance, the drive subassembly 36 preferably includes a crank handle 56 mounted to the rod 44, to facilitate manual rotation of the rod by the operator. The counter 54 preferably includes a display 58 that enables the operator to rotate the rod 44 in accordance with predetermined instructions, in order to move the lane guide element 30 transversely by the predetermined distance “F” in the predetermined direction. As an example, the instructions may indicate that, for a first container, the counter should be at a particular number (e.g., 4000), and for a second container having a different size, the counter should be at another number (e.g., 4010). Accordingly, using the counter and the instructions, the operator rotates the rod 44 as required to achieve the desired result.

It will be understood that, in practice, the adjustments to accommodate new containers (i.e., by changing the lane widths) preferably are effected by appropriate rotation of the rod 44 of each of the relevant lane guide adjustor modules 32 respectively, such rotation being limited to a predetermined number of rotations that are counted by the counter 54.

Those skilled in the art would appreciate that, depending on the changes in lane widths that are required, only the positions of certain of the lane guide adjustor modules 32 may be required to be changed. For instance, as described above in the example illustrated in FIG. 1E, the centrally-located lane guide adjustor module 32 is not required to move to effect the desired changes in lane widths, because the position of the lane guide element 30B was to be unchanged in that example.

From the foregoing, it can be seen that in one embodiment, manual operation of the crank 56, along with the operator's observation of the counter 54, results in satisfactory control of the transverse movement of the lane guide elements 30. Those skilled in the art would appreciate that, alternatively, the rotation of the rods 44 by the appropriate, predetermined number of rotations, to change the lane widths, may be effected by any suitable means. For example, such rotations could be effected by motors (e.g., electric, or hydraulic) that rotate the rods 44 by the predetermined number of rotations.

In one embodiment, the drive gear train 48 preferably includes a worm drive 60. Preferably, the worm drive 60 includes a worm wheel 62 coaxial with and secured to the drive element 38 (FIGS. 2D, 2E), and a worm 64 coaxial with and secured to the rod 44 and meshably engaged with the worm wheel 62, for rotation of the drive element 38 upon rotation of the rod 44. For instance, as can be seen in FIG. 2G, rotation of the worm 64 in the direction indicated by arrow “I₁” causes corresponding rotation of the worm wheel 62 in the direction indicated by arrow “J₁” in FIG. 2G. Because the worm wheel 62 is secured to and coaxial with the drive element 38, the rotation of the worm wheel 62 initiated by the worm 64 causes the drive element 38 to rotate about its axis “X”. Similarly, rotation of the worm 64 in the direction indicated by arrow “I₂” causes corresponding rotation of the drive element 38 in the direction indicated by arrow “J₂” (FIG. 2G).

As noted above, the drive subassembly 36 preferably also includes a pinion 52 that is also mounted on the drive element 38, and coaxial with the drive element 38. Rotation of the drive element 38, initiated by rotation of the rod 44 that causes the rotation of the worm 64 as noted above, thus results in transverse movement of the lane guide adjustor module 32 along the cross-member 34 on which it is mounted.

It will be understood that the teeth of each of the worm wheel 62 and the worm 64 are omitted from FIGS. 2D and 2E for clarity of illustration.

As can be seen in FIG. 2C, it is preferred that the lane guide adjustor module 32 includes a body portion 65. Preferably, the body portion 65 includes a number of parts. It will be understood that three of the entire lane guide adjustor modules 32 are illustrated in FIG. 2C, i.e., with no parts omitted. However, it will also be understood that parts of the body portion 65 of the lane guide adjustor module 32 shown on the left in FIG. 2C are omitted from FIGS. 2D and 2E, in order to show the elements of the drive subassembly 36. It will be understood that the rod 44, the worm 64, and the worm wheel 62, and the drive element 38 are rotatably mounted in the body portion 65, i.e., such parts of the drive subassembly 36 are mounted partially or wholly inside the body portion 65 so that they can rotate within the body portion 65 without causing rotation of the body portion 65.

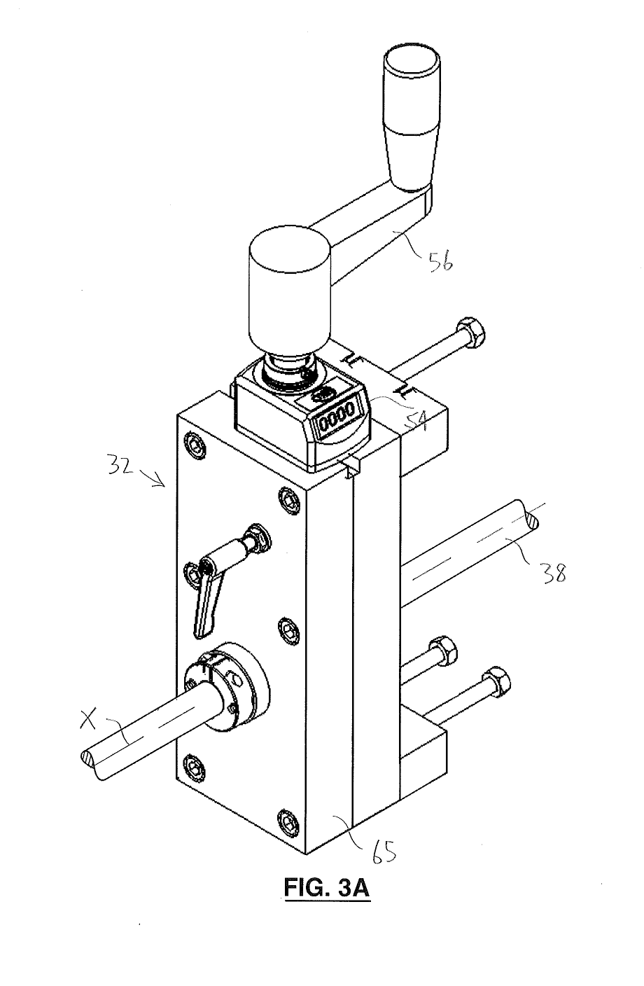

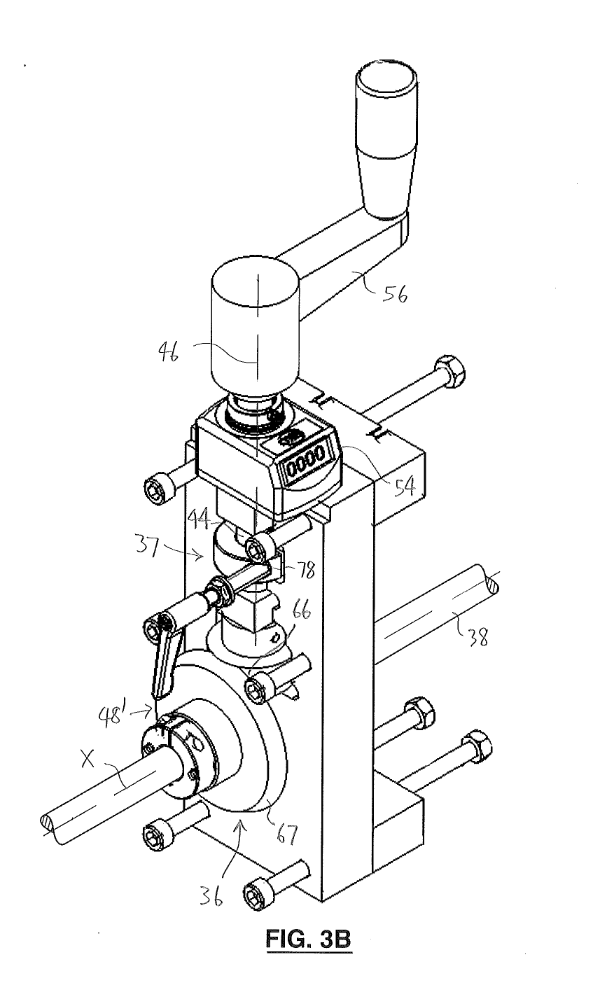

An alternative embodiment of the drive gear train 48′ is illustrated in FIG. 3B. In this embodiment, the gear train preferably includes a first bevel gear 66, coaxial with and secured to the rod 44, and a second bevel gear 67, coaxial with and secured to the drive element 38 (FIG. 3B). It is preferred that the first and second bevel gears 66, 67 are meshably engaged with each other so that rotation of the rod 44 about the rod axis 46 causes corresponding rotation of the drive element 38 about the axis of rotation “X” thereof.

It will also be understood that the teeth of the first and second bevel gears 66, 67 are omitted from FIG. 3B for clarity of illustration.

Selected parts of the body 65 of the lane guide adjustor module 32 are also omitted from FIG. 3B, for clarity of illustration.

As can be seen in FIGS. 1B-1E, the lane guide support modules 40 preferably support the respective lane guide elements 30 at points intermediate between the lane guide adjustor modules 32 that are secured to the lane guide elements 30 respectively. It is preferred that the support subassembly 42 of each lane guide support module 40 also controls the transverse movement of the lane guide element 30 to which it is secured. In one embodiment, the cross-member 34 on which the lane guide support module 40 is mounted preferably includes a support rack 68 extending along at least a portion thereof (FIGS. 2I, 2J). Also, the support subassembly 42 preferably includes a support pinion gear 70 coaxial with and secured to the drive element 38 and meshably engaged with the support rack 68, for linear motion of the lane guide support module 40 along the selected support one of the cross-members 34 upon rotation of the drive element 38 (FIGS. 2J, 4D).

Those skilled in the art would appreciate that various alternative mechanisms may be used to effect controlled transverse movement of the lane guide support module 40, and the lane guide element(s) 30 to which the lane guide support module 40 is attached. For instance, instead of the rack-and-pinion mechanism described above, a lead screw mechanism, or a worm drive, may be used.

As can be seen in FIGS. 2I and 4A-4D, the lane guide support module 40 preferably includes a housing 72. It is also preferred that the lane guide support module 40 includes one or more clamps 74 that secure the support pinion gear 70 to the drive element 38.

It will be understood that, in FIGS. 2J and 4D, certain portions of the housing 72 are omitted, in order that the support subassembly 42 may be shown. Referring to the lane guide support module 40 that is secured to the lane guide element identified by reference numeral 30′ in FIG. 2J, rotation of the drive element 38 about its axis of rotation “X” is initiated at the one or more lane guide adjustor modules 32 (not shown in FIG. 2J) that are also secured to the lane guide element 30′. As can be seen in FIG. 2J, rotation of the drive element 38 causes the support pinion gear 70 to rotate, which moves the lane guide support module 40 transversely, i.e., along the cross-member 34. For instance, rotation of the drive element 38 and the support pinion gear 70 in the direction indicated by arrow “K₁” causes the lane guide support module 40 to move along the cross-member 34 in the direction indicated by arrow “L₁” (FIG. 2J). Similarly, rotation of the drive element 38 in the direction indicated by arrow “K₂” causes the lane guide support module 40 to move in the direction indicated by arrow “L₂” (FIG. 2J).

From the foregoing, it can be seen that the rotation of the drive element 38 by a number of rotations that causes the lane guide adjustor module 32 to move the predetermined distance “F” in the predetermined direction also causes the lane guide support module 40 to move the predetermined distance “F” in a direction that, in the straight lane adjustment subsystem “B”, is parallel to the predetermined direction in which the lane guide adjustor module 32 is moved.

As can be seen in FIGS. 4A-4D, the lane guide support module 40 preferably includes a mounting member 75 secured to the housing 72, to which the lane guide element 30 (not shown in FIGS. 4A-4D) may be secured. The housing 72 preferably also includes a slot 77 defined therein in which the cross-member 34 is receivable, as will be described.

As can be seen in FIGS. 2C-2G, the lane guide adjustor module 32 preferably also includes the lock subassembly 37. Preferably, the lock subassembly 37 includes a brake element or brake clamp 76 (FIG. 2F) that is positioned for engagement with the rod 44, and a lock element 78 (FIG. 2F) for moving the brake element 76 between a locked condition (FIGS. 2F, 2G, in which the brake element 76 engages the rod 44 to prevent its rotation about its axis 46, and a released condition (FIG. 2E), in which the brake element 76 is disengaged from the rod 44 so as to permit the rod 44 to rotate.

As can be seen in FIGS. 2F and 2G, the brake element 76 preferably is a clamp or a split ring that is formed to fit around the rod 44. The lock element 78 preferably includes a handle part 80 and a shaft part 82 that are connected, as can be seen in FIGS. 2E and 2F. Preferably, the shaft part 82 extends through a hole 84 in the brake element 76 (FIGS. 2E, 2F). Rotational movement of the shaft part 82 in the hole 84 in a first direction pulls the split ring brake element 76 tightly against the rod 44 (i.e., to prevent rotation of the rod 44 about its axis 46), and rotation of the shaft part 82 in a second (opposite) direction loosens the brake element 76, so that the brake element 76 is disengaged, or at least partly disengaged, from the rod 44.

As can be seen in FIG. 2C, movement of the handle part 80 in the first direction, indicated by arrow “M”, tightens or engages the brake element 76. If rotated sufficiently in this direction, the lock element 78 is locked, and the brake element 76 prevents rotation of the rod 44. It will be understood that, in FIG. 2C, the lock subassembly 37 is in the locked condition when the handle part 80 is in a first position, in which the handle part 80 is illustrated in solid outline. The handle part 80 is shown in a dashed outline in a second position it is in when the lock subassembly 37 is in the unlocked condition.

As noted above, the drive train 48 is secured to the drive element 38. For instance, in the embodiment in which the drive train 48 includes the worm drive, the worm wheel 62 is secured to (and coaxial with) the drive element 38, and the worm 64 is secured to (and coaxial with) the rod 44. Also, the worm wheel 62 and the worm 64 are meshably engaged. Accordingly, because the lock subassembly 37 prevents rotation of the rod 44 when the lock element 78 is locked, the lock subassembly 37 also prevents rotation of the drive element 38 when the lock element 78 is locked.

Similarly, in the drive gear train 48′, the first bevel gear 66 is secured to (and coaxial with) the rod 44. Also, the second bevel gear 67 is secured to (and coaxial with) the drive element 38. The first and second bevel gears 66, 67 are meshably engaged with each other. Accordingly, in connection with the drive gear train 48′ also, because the lock subassembly 37 prevents rotation of the rod 44 when the lock element 78 is locked, the lock subassembly 37 also prevents rotation of the drive element 38 when the lock element 78 is locked.

It can be seen, therefore, that once the lane guide adjustor module 32 (and the guide element 30 secured thereto) is moved to a precise position by rotation of the rod 44, the lane guide adjustor module 32 can be locked into that position by the lock subassembly 37.

Similarly, if the handle part 80 is rotated in the appropriate direction, the brake element 76 is unlocked, so that the rod 44 is rotatable about its axis 46. When the position of the lane guide adjustor module 32 is to be changed (i.e., when the position of the guide element 30 is to be adjusted), the lock subassembly 37 is first unlocked.

As noted above, the lane guide adjustor module 32 preferably is secured to the guide element 30. This attachment may be effected using any suitable fastening means 88, as can be seen in FIGS. 2C and 2D. For example, as can be seen in FIG. 2C, the body 65 preferably is secured to the guide element 30 by bolts and nuts.

Similarly, and as can be seen in FIGS. 2I and 2J, the housing 72 of the lane guide support module 40 preferably is secured to the lane guide element 30 by one or more suitable fasteners 90.

The straight lane adjustment subsystem “B” is formed to adjust the lane guide elements 30 that are located along a substantially straight portion of the conveyor(s) 24. From the foregoing, it can be seen that, in the straight lane adjustment subsystem “B”, the transverse movement of the lane guide adjustor modules 32 and the lane guide support modules 40 along the cross-members 34 to which they are respectively mounted preferably is initiated at the lane guide adjustor modules 32. Such movement is transverse relative to the preselected direction. Such movement is also precisely controlled so that it is over the predetermined distance “F” and in the predetermined direction (i.e., along the respective cross-members to which the lane guide adjustor modules 32 and the lane guide support modules 40 are respectively mounted).

As illustrated in FIG. 1A, the other subsystems of the system 20 are formed for adjustment of the lane guide elements along portions of the conveyor(s) 24 that are generally not substantially straight, or are nonaligned.

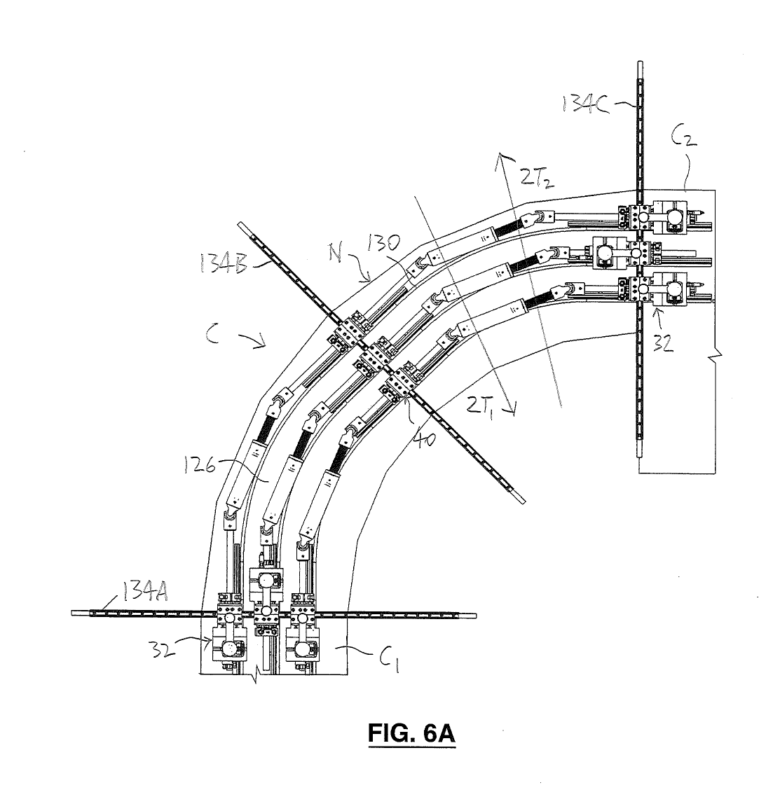

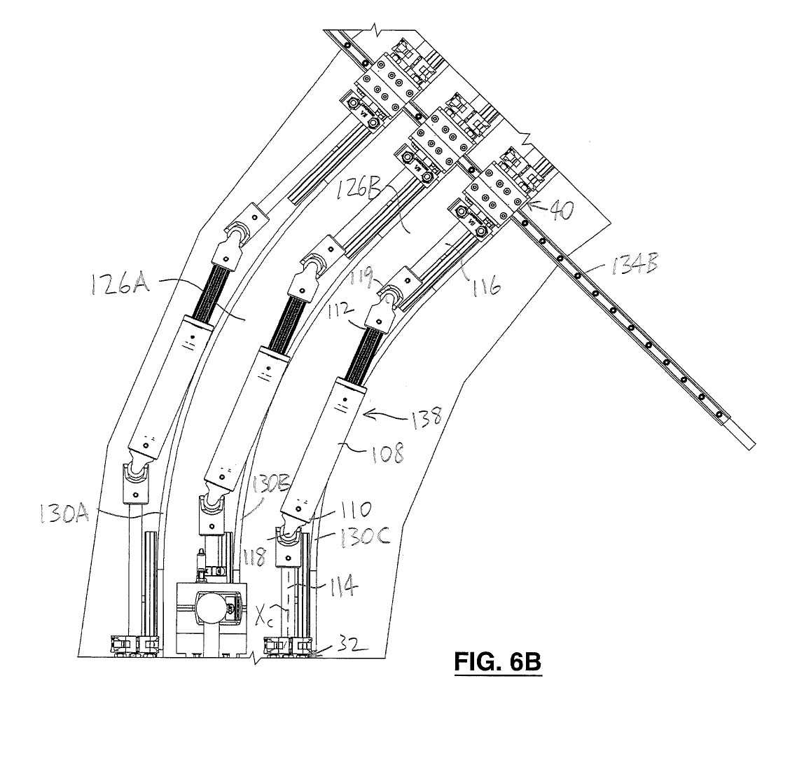

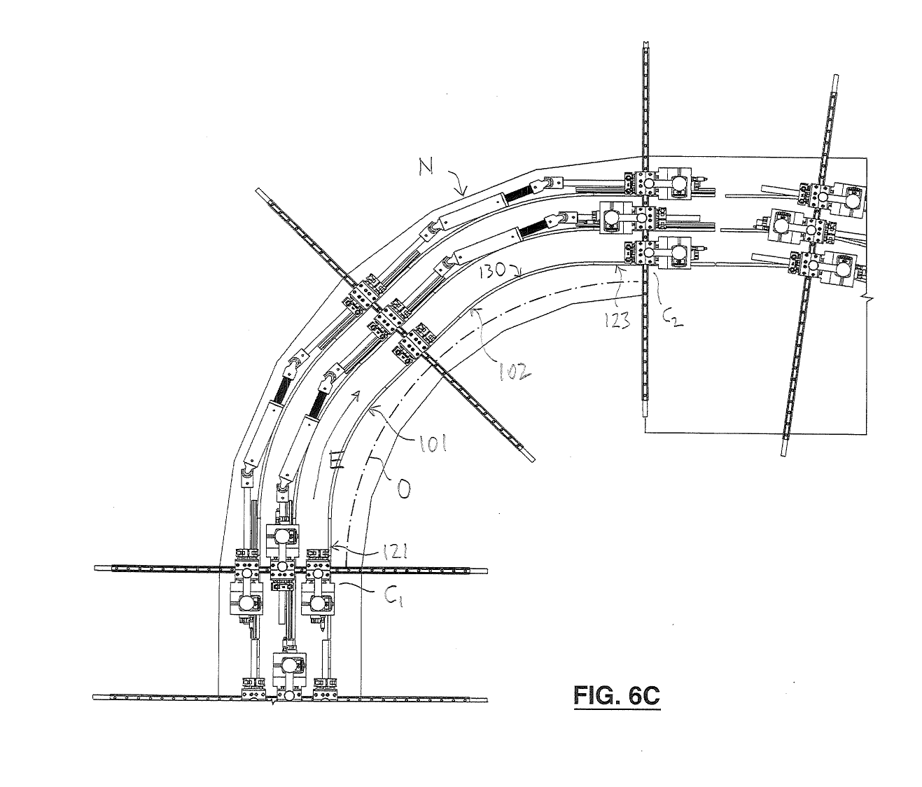

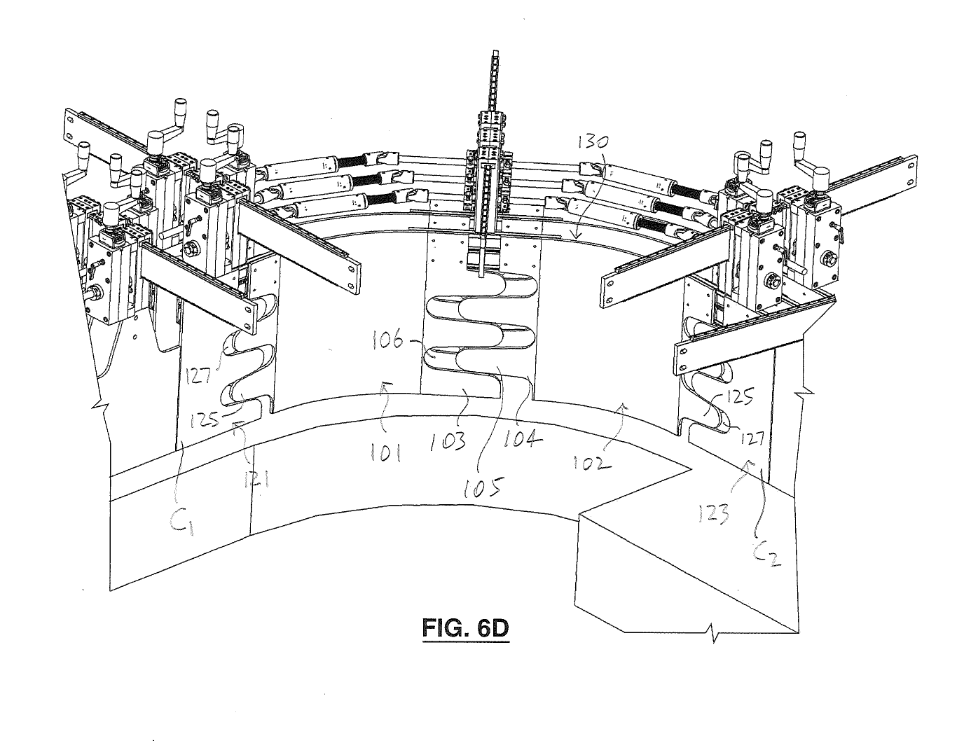

As can be seen in FIG. 6A, in one embodiment, the conveyor 24 preferably includes a corner portion “N” thereof that is defined by an arc “0”. Preferably, the corner lane guide adjustment subsystem “C” of the lane guide adjustment system 20 includes a number of lane guide elements 130. As can be seen in FIGS. 6A-6D, the lane guide elements 130 preferably are formed to be located above the corner portion “N” of the conveyor(s) 24. It is also preferred that each of the lane guide elements 130 positioned above the corner portion “N” includes first and second parts 101, 102 (FIG. 6D). The first and second parts 101, 102 preferably include respective internal ends 103, 104 at which a plurality of fingers 105 of each of the internal ends 103, 104 at least partially interlock with each other. As can be seen in FIG. 6D, each of the ends 101, 102 preferably includes slots or openings 106 in which the fingers 105 of the other internal end are receivable.

In the corner lane guide adjustment subsystem “C”, the containers are moved in the preselected direction indicated by arrow “E” (FIG. 6C), i.e., in a direction generally parallel to the arc “O”. The lane guide elements 130 define lanes 126 along which the containers are moved by the conveyor(s) 24. When the lane guide elements 130 are adjusted, to change the lane widths, the lane guide elements 130 are moved generally transversely to the preselected direction “E”.

It will be understood that, when the lane guide elements 130 are moved generally transversely relative to the preselected direction “E”, the fingers 105 are moved into, or out of, the slots 106. For instance, when the lane guide elements 130 are moved outwardly (i.e., in the direction indicated by arrow “2T₂” in FIG. 6A), the fingers 105 are moved partially out of the slots 106. When the lane guide elements 130 are moved inwardly (i.e., in the direction indicated by arrow “2T₁” in FIG. 6A), the fingers 105 are moved partially into the slots 106.

As can be seen in FIG. 6A, the corner lane adjustment subsystem “C” preferably extends between upstream and downstream ends “C₁”, “C₂”. As illustrated, the upstream end “C₁” is adjacent to the downstream end “B₂” of the straight lane adjustment subsystem “B”. It will be understood that the lanes 126A and 126B that are defined between the lane guide elements 130A and 130B, and between 130B and 130C respectively in FIG. 6B are substantially aligned with the lanes 26A, 26B of the straight lane subsystem “B”.

It will be understood that the lane elements 130 are formed so that the fingers 105 are not moved entirely out of the slots 106 when the subsystem “C” is in use. Because of this, the lane guide elements 130 are able to guide the containers (not shown in FIGS. 6A-6D) along the corner portion “N” of the conveyor(s) 24, i.e., each of the lane guide elements 130 forms a substantially continuous surface(s) along its length, from the upstream end “C₁” to the downstream end “C₂”.

For convenience, the three lane guide elements are identified in FIG. 6C as 126A, 126B, and 126C.

The cross-members 134 of the corner lane guide subsystem “C” are identified by reference numerals 134A-134C for convenience in FIG. 6A. As can be seen in FIG. 6A, in one embodiment, the lane guide elements 130A, 130B, and 130C preferably are connected to lane guide adjustor modules 32 on the cross-member 134A located at the upstream end “C₁” and also to the lane guide adjustor modules 32 located at the downstream end “C₂”, mounted on the cross-member 134C. Preferably, the subsystem “C” also has lane element support modules 40 mounted on the cross-member 134B, which are also secured to the lane guide elements 130A, 130B, and 130C.

It will be understood that the lane guide adjustor modules 32 and the lane guide adjustor modules 40 in the subsystem “C” are the same as those described above, and function in the same way.

From the foregoing it can be seen that inward and outward movement of the lane guide elements 130 causes them to move not only generally transversely, but also partially in the preselected direction, indicated by “E” in FIG. 6C. Those skilled in the art would appreciate that the fingers that fit into the slots enable the lane guide elements 130 to move generally inwardly and generally outwardly and also provide partially continuous surfaces along their respective lengths between the upstream and downstream ends “C₁”, “C₂”, despite such movement.

Although the lane guide adjustor modules 32 and the lane guide support modules 40 operate as described above, those skilled in the art would appreciate that an alternative embodiment of the drive element 138 of the invention preferably is included in the corner lane adjustment subsystem “C”.

In one embodiment, the drive element 138 positioned above the corner portion “N” preferably includes an elongate telescoping central segment 108 extending between first and second ends 110, 112 thereof (FIG. 6B). Preferably, the corner lane adjustment subsystem “C” also includes a first drive element segment 114 engaged with the drive subassembly of the lane guide adjustor module 32 on the cross-member 134A and extending over the corner portion “N” from such lane guide adjustor module 32. Preferably, the corner lane adjustment subsystem “C” also includes a second drive element segment 116 engaged with the support subassembly of the lane guide support module 40 on the cross-member 134B and extending over the corner portion “N” from such lane guide support module 40. It is also preferred that the corner lane adjustment subsystem “C” includes first and second universal joints 118, 119, connecting the first and second ends 110, 112 of the central segment 108 respectively with the first drive element segment 114 and the second drive element segment 116.

As described above, the substantially transverse movement of a particular one of the lane guide elements 130 preferably is initiated at one of the lane guide adjustor modules 32 secured to that lane guide element. Via the drive subassembly 36 of such lane guide adjustor module 32, the first drive element segment 114 is rotated about its axis, identified by the reference letter “X_{C}” in FIG. 6B for convenience. This causes corresponding rotation of the first universal joint 118, which also causes corresponding rotation of the central segment 108, and also of the second universal joint 119 and the second drive element segment 116. The corresponding rotation of the second drive element segment 116 about its axis, via the support subassembly 42, causes corresponding linear movement of the lane guide support module 40 along the cross-member 34 on which it is mounted, as described above.

From the foregoing, it can be seen that the drive element 138 enables the first and second parts 101, 102 of the lane guide element 130 to move generally inwardly and outwardly, as required to change the lane widths. To the extent that such movement involves movement of the parts 101, 102 in the preselected direction (or opposite to the preselected direction, as the case may be), the telescoping central segment 108 accommodates such movement.

It will be understood that one of the drive elements 138 is omitted from FIG. 6C so that one of the lane guide elements 130 may be seen, i.e., the innermost lane guide element 130. As can be seen in FIGS. 6C and 6D, in one embodiment, the lane guide element 130 preferably includes end portions 121, 123 that are located at the upstream and downstream ends “C₁”, “C₂” of the corner lane guide subsystem “C” respectively. Preferably, the first and second parts 101, 102 also include fingers 125 and slots 127 that cooperate with fingers 125 and slots in the respective end parts 121, 123. In this way, the lane guide element 130 provides a substantially continuous surface for engagement with the containers 22 (not shown in FIGS. 6A-6D) from the upstream end “C₁” to the downstream end “C₂” after substantially transverse movement of the lane guide element 130.

As can be seen in FIG. 6A, the lanes defined in the corner lane adjustment subsystem “C” preferably are substantially aligned with respective corresponding lanes 26 in the adjacent subsystems “B”, “D”.

As can be seen in FIGS. 1A and 1B, the funnel lane adjustment subsystem “A” extends between upstream and downstream ends thereof “A₁”, “A₂”. In FIGS. 5A-5C, the cross-members of the subsystem “A” are identified for convenience as 234A, 234B, and 234C.

Preferably, the conveyor 24 includes a funnel portion “P” thereof (FIG. 1B) extending between the upstream and downstream ends that are located at the upstream and downstream ends “A₁”, “A₂” of the subsystem “A”. Preferably, the lane guide elements 230 define one or more lanes 226 therebetween to have an upstream lane width 228_{U} at the upstream end “A₁” that is greater than a downstream lane width thereof 228_{D} at the downstream end “A₂”. Preferably, each of the lanes 226 tapers gradually from the upstream end “A₁” to the downstream end “A₂”. As can be seen in FIG. 1B, in the embodiment illustrated, the funnel lane guide subsystem “A” preferably includes respective groups of lane guide adjustor modules 32 at the upstream and downstream ends “A₁”, “A₂”, mounted on the cross-members 234A, 234C (FIGS. 5A, 5C). It is also preferred that the funnel lane guide subsystem “A” includes a group of lane guide support modules 40 mounted to the cross-member 234B (FIG. 5B). The lane guide adjustor modules 32 located at the upstream and downstream ends respectively are illustrated in FIGS. 5A and 5C respectively, and the lane guide support modules 40 are illustrated in FIG. 5B.

It will be understood that the lane guide adjustor modules 32 and the lane guide support modules 40 included in the funnel lane guide adjustment subsystem “A” are the same as those described above, and function in the same way.

The preselected direction in which the containers are moved is indicated by arrow “E” in FIGS. 5A-5C. As can be seen in FIGS. 5A-5C, the lane widths 228 of the lanes 226 defined between the lane guide elements 230 gradually decrease along the length of the subsystem “A”, from the upstream end “A₁” to the downstream end “A₂”. As would be appreciated by those skilled in the art, the lanes 226 at the upstream end are wider due to the processes involving the containers 22.

Although the lane guide elements 230 are movable in generally transverse directions relative to the preselected direction by the lane guide adjustor modules 32, from the foregoing, it can be seen that the predetermined distance by which the lane guide elements 230 are transversely moved at the upstream and downstream ends respectively may not be the same. For this reason, although the drive subassemblies 36 of the lane guide adjustor modules 32 are secured to respective drive elements 238, such drive elements 238 are short (FIG. 5D). The short drive elements 238 only provide an operable connection between the drive gear train 48 in each lane guide module 32 and the pinion gear 52, so that movement initiated by rotating the rod 44 in each lane guide adjustor module 32 causes substantially transverse movement of the respective lane guide adjustor module 32 along the cross-member on which the lane guide adjustor module 32 is mounted. It will be understood that certain parts of the body 65 of the central lane guide adjustor module 32 are omitted from FIG. 5D in order to show the short drive element 238.

It would also be appreciated by those skilled in the art that the lane guide support modules 40 support the respective lane guide elements 238 to which they are secured. In subsystem “A”, because the desired transverse movement is different at each of the cross-members, the lane guide adjustor modules 32 and the lane guide support modules 40 in the subsystem “A” preferably are not operably connected by drive elements.

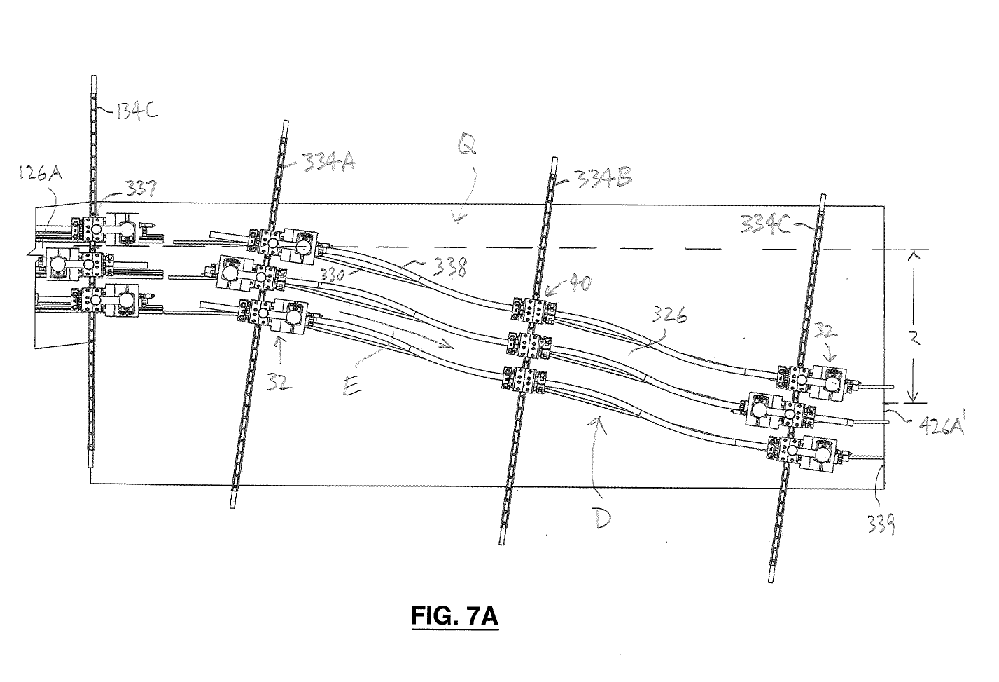

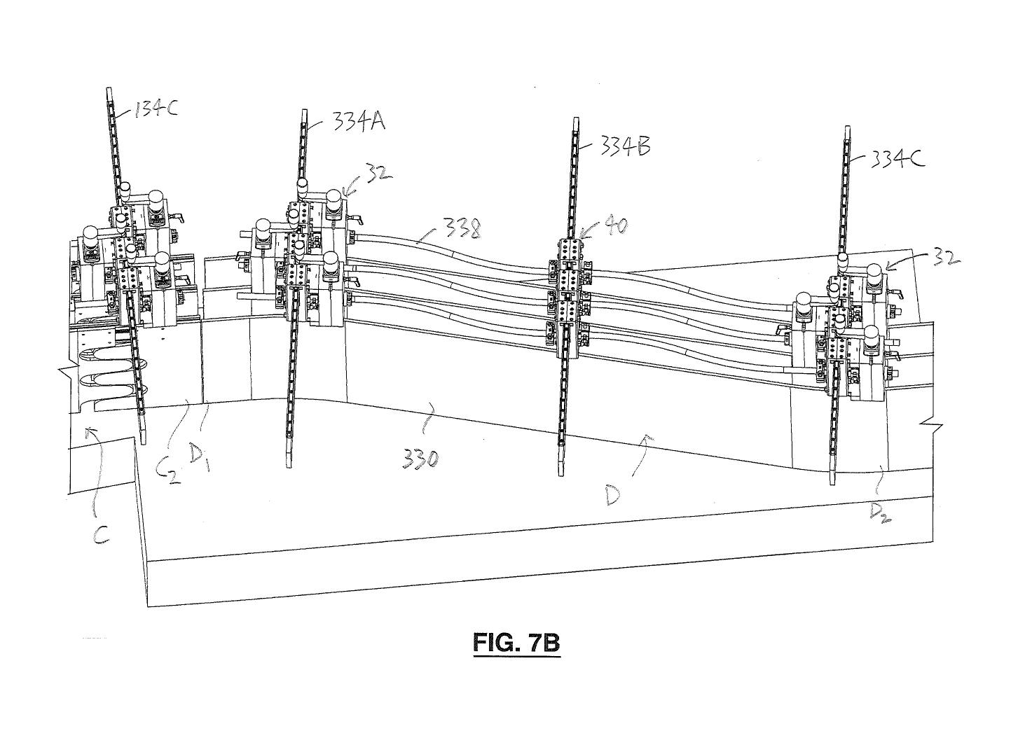

As can be seen in FIGS. 7A and 7B, the transition lane guide adjustment subsystem “D” is mounted above a transition portion “Q” of the conveyor(s) 24. The transition portion “Q” extends between upstream and downstream ends thereof adjacent to upstream and downstream ends “D₁”, “D₂” of the subsystem “D”.

Preferably, the conveyor 24 includes the transition portion “Q” located between upstream and downstream ends thereof that are located at the upstream and downstream ends “D₁”, “D₂” of the subsystem “D”. As can be seen in FIG. 7A, the upstream and downstream portions are longitudinally nonaligned. As can be seen in FIGS. 7A and 7B, the subsystem “D” preferably includes lane guide elements 330 that are positioned to guide the containers 22 (not shown in FIGS. 7A, 7B) from the upstream portion to the downstream portion of the conveyor(s) 24.

As illustrated, the end “D₁” is located adjacent to the downstream end “C₂”, of the corner lane adjustment subsystem “C” (FIG. 7B).

It will be understood that the conveyor portion “Q” extends between a downstream end 337 of the corner portion “N” of the conveyor(s) 24 and an end 339 of another portion of the conveyor(s) 24, or a target location (FIG. 7A). The ends 337, 339 are not longitudinally aligned. That is, a lane 126A, if projected in a straight line from the end 337, would not align with a corresponding path 426A′ at the end 339. This is illustrated in FIG. 7A, in which the extent of nonalignment is identified as “R”.

Those skilled in the art would appreciate that the transition portion “Q” may be required where the upstream and downstream ends 337, 339 are not aligned. In the example illustrated in FIGS. 7A and 7B, the subsystem “D” includes three cross-members 334A, 334B, 334C that are positioned substantially transverse to the preselected direction of travel “E” of the containers 22 (not shown in FIGS. 7A, 7B). The subsystem “D” preferably also includes lane guide adjustor modules 32 mounted on the cross-members 334A, 334C. Preferably, the subsystem “D” also includes the lane guide support modules 40 mounted to the cross-member 334B. As can be seen in FIGS. 7A and 7B, the lane guide adjustor modules 32 and the lane guide support modules 40 are secured to lane guide elements 330.

It will be understood that the lane guide adjustor modules 32 and the lane guide support modules 40 in the subsystem “D” are the same as those described above, and function in the same way.

Because the ends 337, 339 are not aligned, the transition lane guide adjustment subsystem “D” defines a curve therebetween. However, this means that, in the subsystem “D”, the lane guide adjustor modules 32 and the lane guide support modules 40 that are attached to the same lane guide element 330 are also not longitudinally aligned. Accordingly, it is also preferred that the subsystem “D” includes flexible drive elements 338 operably connecting the lane guide adjustor modules 32 and the lane guide support modules 40. The flexible drive elements 338 are preferred because they function properly even though they are following the curve defined by the subsystem “D” overall. Also, the lane guide elements 330 are formed to be somewhat flexible, so that they also can define the lanes 326 therebetween that are curved.

As can be seen in FIG. 2B, the lane guide adjustor module 32 preferably includes an engagement element 41 formed for engagement with the cross-member 34. Similarly, and as can be seen in FIG. 2I, the lane guide support module 40 preferably also includes a support engagement element 43 formed for engagement with the cross-member 34.

In one embodiment, the cross-member 34 preferably includes an upper element 45 positioned along a top edge 47 of the cross-member 34, and grooves 49 positioned between the top edge 47 and a bottom edge 51 of the cross-member 34 (FIG. 2I). (It will be understood that one groove 49 is positioned on each side of the cross-member 34.) In the embodiment illustrated in FIGS. 2A-2J, the grooves 49 are positioned only a relatively short distance below the upper element 45.

It will be understood that the cross-member 34 on which the lane guide adjustor module 32 is mounted also includes the upper element 45 mounted along the top edge 47 thereof, and grooves 49. It will also be understood that the engagement element 41 and the support engagement element 43 are generally similar.

In one embodiment, the body 56 of the lane guide adjustor module 32 preferably also includes the engagement element 41, as can be seen, for instance, in FIG. 2B.

Also, the housing 72 of the lane guide support module 40 preferably includes the support engagement element 43 (FIG. 2I).

It is preferred that each of the engagement element 41 and the support engagement element 43 is formed for slidable engagement with the upper element 45, the grooves 49, and intermediate portions 53 that are located between the upper element 45 and the grooves 49 (FIG. 2I). The upper element 45, the grooves 49, and the intermediate portions 53 preferably are made of any suitable material or materials. Those skilled in the art would be aware of suitable materials. For example, the upper element 45 may be made of hard anodized aluminum or stainless steel. It is preferred that each of the engagement element 41 and the support engagement element 43 is made of material or materials with relatively high lubricity. For example, the engagement element 41 and the support engagement element 43 may be made of ultra high molecular weight polyethylene (UHMWPE), polyretraflueroethylene (PTFE), or high-density polyethylene (HDPE). Each of the engagement element 41 and the support engagement element 43 preferably is formed for sliding engagement with the upper element 45.

It is also believed that, in order to adjust the position of a lane guide element 30 that is relatively long and straight, e.g., approximately 20 or 30 feet long, the transverse adjustment of the position of the guide element preferably is done using two lane guide adjustor modules, i.e., one at each end of the guide element, as illustrated in FIGS. 1B and 1C. It is believed to be advantageous to use two lane guide adjustor modules for accuracy, due to friction affecting the extent of transverse movement achievable at points relatively distant from the lane guide adjustor module at which the rotation of the drive element is initiated.

In use, the adjustment process preferably begins by unlocking the lane guide adjustor modules connected to the same drive element 38, e.g., at each of the upstream and downstream ends “B₁”, “B₂” (FIG. 1C). For a particular guide element, e.g., the guide element 30A, the lane guide adjustor module 32A₁ is then positioned as required, and subsequently locked into position. As noted above, the user preferably utilizes the counter 54 included in the lane guide adjustor module 32A₁ that is used in order to achieve accurate positioning. Next, at the other end of the drive element 38A, the lane guide adjustor module 32B₁ is positioned as required, and subsequently locked into position. Preferably, the user relies on the counter 54 of the lane guide adjustor module 32B₁ in order to achieve accurate positioning. The lane guide adjustor module 32B₁ is also then locked into position. Once this has been done, the lane guide element 30A is in the required (i.e., adjusted) position.

It is believed that, in most circumstances, the adjustment required at the second lane guide adjustor module 32B₂ is relatively small. This process (i.e., of adjusting the position of the lane guide element 30 via lane guide adjustor modules located at both ends of the drive element 38 for that lane guide element 30) is believed to be advantageous, in practice, where the length of the drive element 38 is greater than about five feet. As noted above, the adjustment at the other end of the drive element is believed to be due to friction (e.g., between the teeth of the pinion and those of the rack). That is, where the drive element 38 is relatively long, the drive element 38 may not be not fully rotated at its end that is distal to the lane guide adjustor module at which the rotation is initiated.

The foregoing discussion refers to the straight lane adjustment subsystem “B”, as an example. It will be understood that a generally similar process would be used in adjusting the portions of the lane guide elements 30 in the other subsystems “A”, “C”, and “D”. In subsystem “A”, however, the drive elements 38 do not operatively connect the lane guide adjustor modules 32 and the lane guide support module 40, as described above.

As can be seen in FIG. 2A, the cross-members 34 preferably are supported by support elements 55. Those skilled in the art would appreciate that the support elements 55 may be any suitable support members or devices, and the support elements 55 that are illustrated in FIG. 2A are exemplary only. Those skilled in the art would also appreciate that the system 20 may be retrofitted onto a pre-existing conveyor and packaging system by, for example, mounting the cross-members 34 on such support members or devices as are already in position, assuming that the support members or devices are suitable.

As can be seen in FIGS. 2A and 2C, in one embodiment, the lane guide adjustor modules 32 that are mounted to a particular cross-member 34 preferably are positioned with their respective crank handles 56 on opposite sides thereof. In practice, this has been found to be convenient, in order to accommodate the bodies and the cranks of each of the lane guide adjustor modules. In addition, and as can be seen in FIG. 2F, it is preferred that the counters 54 of the lane guide adjustor modules 32 that are mounted on a particular cross-member are positioned so that all of the displays of the counters can be read from the same side of the lane adjustment system 20.

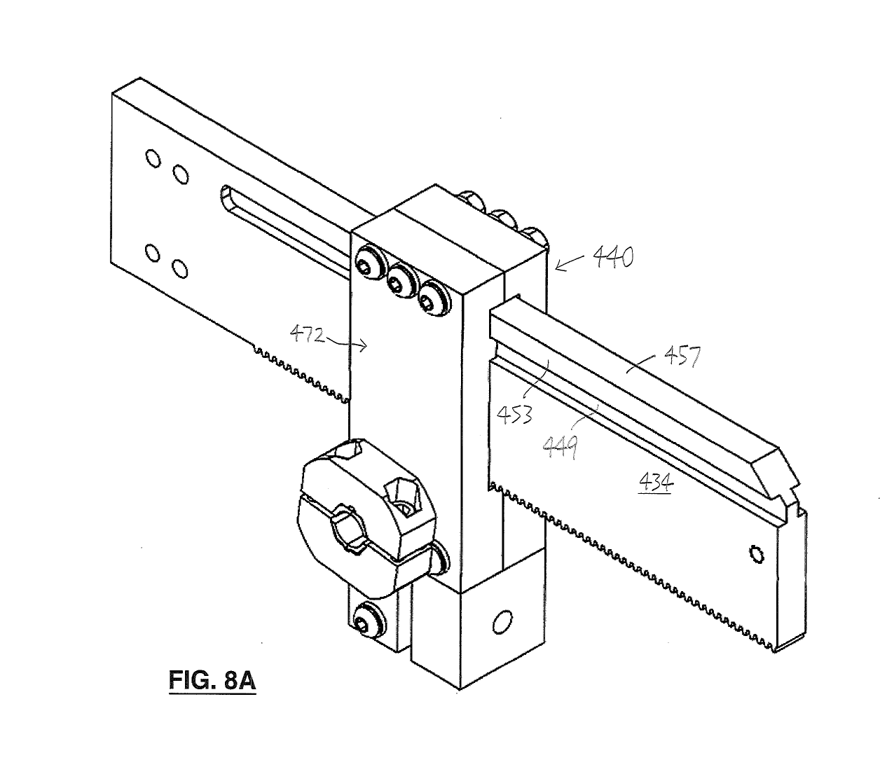

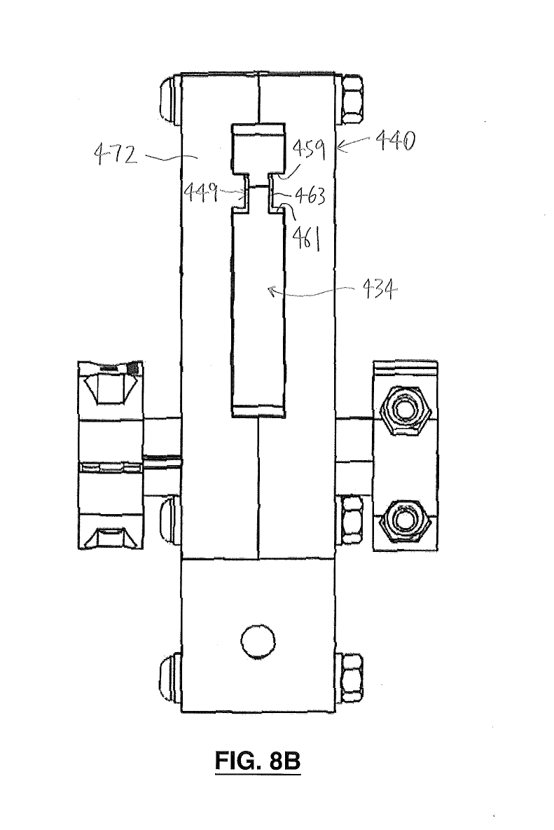

Alternative embodiments of the cross-member 434 and the lane guide support module 440 of the invention are illustrated in FIGS. 8A and 8B. In this embodiment, in order to reduce the costs incurred in manufacturing the lane guide support modules 440, the housing 472 thereof preferably is made entirely of a suitable material having relatively high lubricity, e.g., UHMWPE, or HDPE. This material has sufficient lubricity that the engagement element is not required. It has also been found that forming the cross-member 434 of anodized aluminum provides a cost advantage. As can be seen in FIGS. 8A and 8B, the housing 472 of an embodiment of the lane guide support module 440 preferably is formed so that it engages an upper surface 457, a groove 449, and an intermediate portion 453 of the cross-member 434. It can be seen in FIG. 8B that the groove 449 is formed with walls 459, 461 located substantially orthogonal to a base wall 463. Also, it can be seen in FIG. 8B that the intermediate portions 453 are substantially larger than the intermediate portions 53 of the cross-member 34 (FIG. 2I).

It will be understood that the body of the lane guide adjustor module may also be formed for mounting on the cross-member 434 i.e., formed of a suitable material as described above, so that the engagement element may be omitted therefrom.

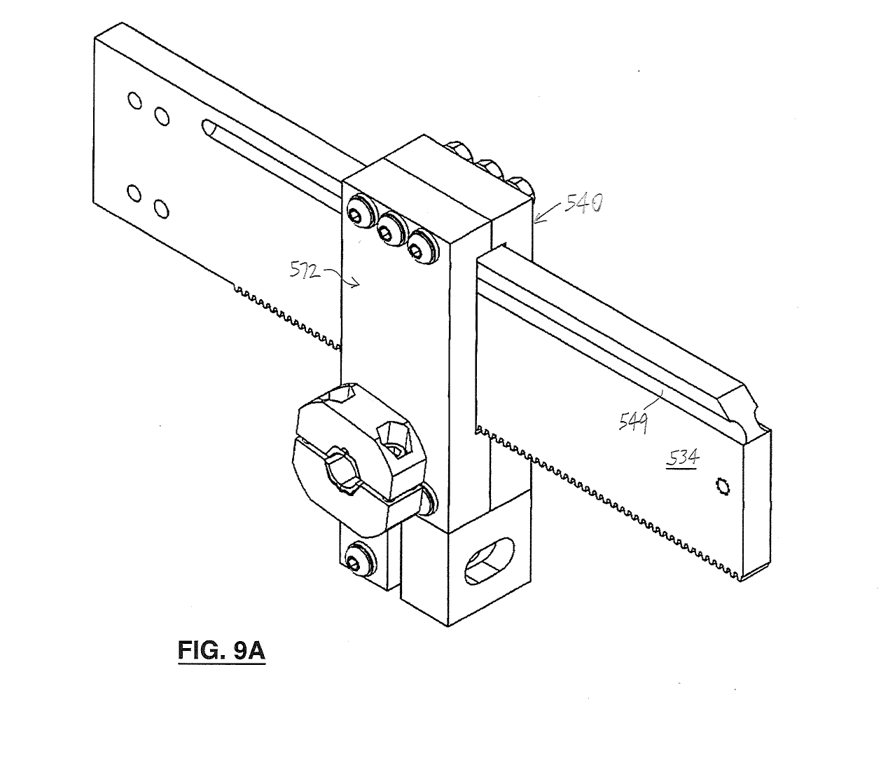

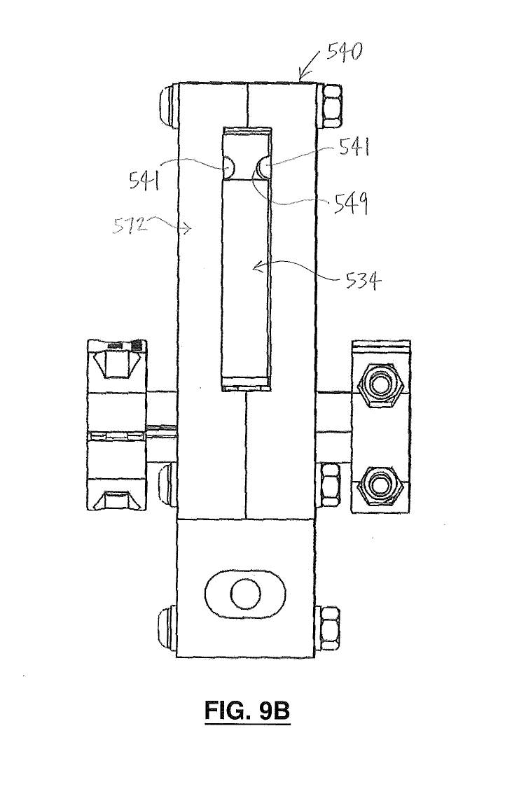

A further alternative embodiment of the cross-member 534 of the invention is illustrated in FIGS. 9A and 9B. In this embodiment, an engagement element 541 (FIG. 9B) is secured in the housing 572 of the lane guide support module 540. The groove 549 preferably is formed so that it has a semi-circular or arc profile, in cross-section (FIG. 9B), although it will be understood that the groove 549 may have any suitable profile.

It will also be understood that the body of the lane guide adjustor module may also be formed for mounting on the cross-member 534, i.e., similar to the housing 572 of the lane guide support module 540.

The invention preferably includes an embodiment of a method of adjusting the lane guide elements 30 defining the respective lanes 26 therebetween. The method includes providing the cross-members 34, which are positioned at least partially transverse to the preselected direction and also positioned spaced apart from each other along the conveyor(s) 24. The method preferably also includes providing the lane guide adjustor module(s) 32 secured to selected ones of the lane guide elements 30 and mounted to selected ones of the cross-members 30. The lane adjustor module 32 preferably includes the drive subassembly 36, for moving the selected one of the lane guide elements 30 the predetermined distance “F” along the selected one of the cross-members, to change the lane width 28 by the predetermined distance.

It is also preferred that the method of the invention includes providing the drive element 38, which is secured to the drive subassembly 36 and rotatable thereby about the drive element axis of rotation “X” in direct relation to linear motion of the lane guide adjustor module 32 over the predetermined distance along the cross-member 34 on which the lane guide adjustor module 32 is mounted. The lane guide support modules 40 are also provided, mounted on the selected cross-members 34. Each of the lane guide support modules 40 includes the support subassembly 42 that is engaged with the cross-member 34 on which the lane guide support module 40 is mounted, and secured to the drive element 38. The lane guide support module 40 preferably is also secured to the selected one of the lane guide elements 30. As described above, the support subassembly 42 preferably is formed to convert rotational motion of the drive element 38 to linear motion of the lane guide support module 40 thereof over the predetermined distance “F” along the cross-member 34 on which it is mounted, to change the lane width 28 by the predetermined distance “F”. Preferably, the drive element 38 is rotated about the drive element axis of rotation “X”, to move the lane guide adjustor module 32 along the cross-member 34 on which it is mounted by the predetermined distance “F”, and to move the lane guide support module 40 along the cross-member 34 on which it is mounted by the predetermined distance “F” to change the lane width 28 of the respective lanes 26 by the predetermined distance “F”.

It will be appreciated by those skilled in the art that, although the steps of methods herein have been described above in a particular order, the steps may be performed in one or more different sequences.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A lane adjustment system for guiding containers moved by at least one conveyor in a preselected direction in at least one lane having a lane width transverse to the preselected direction, the lane adjustment system comprising:
a plurality of lane guide elements, to at least partially define said at least one lane; and
at least one lane guide adjustor module secured to a selected one of the lane guide elements for moving the selected one of the lane guide elements a predetermined distance in a predetermined direction that is at least partially transverse to the preselected direction, to change the lane width by the predetermined distance.

2. A lane adjustment system according to claim 1 in which the predetermined direction is selected from the group consisting of a first direction and a second direction opposite to the first direction that are at least partially transverse relative to the preselected direction.

3. A lane adjustment system according to claim 1 comprising:
a plurality of cross-members positioned at least partially transverse to the preselected direction and spaced apart from each other along said at least one conveyor;
said at least one lane guide adjustor module being mounted on a selected one of the cross-members;
said at least one lane guide adjustor module comprising a drive subassembly; and
the drive subassembly engaging the selected one of the cross-members to move said at least one lane guide adjustor module the predetermined distance in the predetermined direction relative to said at least one conveyor.

4. A lane guide adjustment system according to claim 3 in which:
said at least one lane guide adjustor module additionally comprises a lock subassembly movable between:
a locked condition, in which said at least one lane guide adjustor module is held stationary relative to the selected one of the cross-members, and
an unlocked condition, in which said at least one lane guide adjustor module is movable in the predetermined direction relative to the selected one of the cross-members.

5. A lane adjustment system according to claim 4 additionally comprising:
at least one elongate drive element at least partially defined by an axis of rotation thereof; and
said at least one drive element being secured to the drive subassembly of said at least one lane guide adjustor module for rotation of said at least one drive element by the drive subassembly corresponding to movement of said at least one lane adjustment module in the predetermined direction relative to the selected one of the cross-members.

6. A lane adjustment system according to claim 5 additionally comprising:
at least one lane guide support module mounted to a selected support one of the cross-members;
said at least one lane guide support module being secured to the selected one of the lane guide elements;
said at least one lane guide support module comprising a support subassembly;
the support subassembly being secured to said at least one drive element; and
the support subassembly engaging the selected support one of the cross-members for converting rotation of said at least one drive element to linear motion of said at least one lane guide support module over the predetermined distance along the selected support one of the cross-members relative to said at least one conveyor, to change the lane width by the predetermined distance.

7. A lane adjustment system according to claim 3 comprising:
at least one lane guide support module comprising a support subassembly and mounted on a selected support one of the cross-members;
said at least one lane guide support module being secured to the selected one of the guide elements;
at least one elongate drive element operably connecting the drive subassembly and the support subassembly, said at least one drive element being at least partially defined by a rotation axis thereof, said at least one drive element being rotatable about the rotation axis by the drive subassembly; and
the support subassembly engaging the selected support one of the cross-members for converting rotation of said at least one drive element to linear motion of said at least one lane guide support module over the predetermined distance along the selected support one of the cross-members relative to said at least one conveyor, to move the selected one of the lane guide elements by the predetermined distance.

8. A lane adjustment system for guiding containers moved by at least one conveyor in a preselected direction in at least one lane on said at least one conveyor having a lane width transverse to the preselected direction, the lane adjustment system comprising:
a plurality of lane guide elements, to at least partially define said at least one lane;
a plurality of cross-members positioned at least partially transverse to the preselected direction and positioned spaced apart from each other along said at least one conveyor;
at least one lane guide adjustor module secured to a selected one of the lane guide elements and mounted to a selected one of the cross-members, said at least one lane adjustor module comprising a drive subassembly for moving the selected one of the guide elements a predetermined distance along the selected one of the cross-members, to change the lane width by the predetermined distance;
a drive element secured to the drive subassembly and rotatable thereby about a drive element axis of rotation in direct relation to movement of said at least one lane guide adjustor module over the predetermined distance along the selected one of the cross-members;
at least one lane guide support module mounted on a selected support one of the cross-members, comprising a support subassembly engaged with the selected support one of the cross-members and secured to the drive element;
said at least one lane guide support module being secured to the selected one of the lane guide elements; and
the support subassembly being formed to convert rotational motion of the drive element to linear motion of said at least one lane guide support module over the predetermined distance along the selected support one of the cross-members, to change the lane width by the predetermined distance.

9. A lane adjustment system according to claim 8 in which the drive subassembly comprises:
a rod rotatable about a rod axis thereof; and
a drive gear train connecting the rod and the drive element, for rotation of the drive element about the axis of rotation thereof upon rotation of the rod about the rod axis.

10. A lane adjustment system according to claim 9 in which:
the selected one of the cross-members comprises a rack extending along at least a portion thereof; and
the drive subassembly comprises a pinion gear coaxial with and secured to the drive element and meshably engaged with the rack, for linear motion of said at least one lane guide adjustor module along the selected one of the cross-members upon rotation of the drive element.

11. A lane adjustment system according to claim 10 additionally comprising a counter operably connected with the rod to count rotations of the rod.

12. A lane adjustment system according to claim 9 in which the drive gear train comprises a worm drive, comprising:
a worm wheel coaxial with and secured to the drive element; and
a worm coaxial with and secured to the rod and meshably engaged with the worm wheel, for rotation of the drive element upon rotation of the rod.

13. A lane adjustment system according to claim 9 in which the drive gear train comprises:
a first bevel gear, coaxial with and secured to the rod; and
a second bevel gear, coaxial with and secured to the drive element, the first and second bevel gears being meshably engaged with each other such that rotation of the rod about the rod axis causes corresponding rotation of the drive element about the axis of rotation thereof.

14. A lane adjustment system according to claim 10 in which:
the selected support one of the cross-members comprises a support rack extending along at least a portion thereof;
the support subassembly comprises a support pinion gear coaxial with and secured to the drive element and meshably engaged with the support rack, for linear motion of said at least one lane guide support module along the selected support one of the cross-members upon rotation of the drive element.

15. A lane adjustment system according to claim 13 in which:
said at least one conveyor comprises a corner portion thereof that is defined by an arc; and
each of the lane guide elements positioned above the corner portion comprises first and second parts, the first and second parts comprising respective internal ends at which a plurality of fingers of each said internal end at least partially interlock with each other.

16. A lane adjustment system according to claim 15 in which the drive element positioned above the corner portion comprises:
an elongate telescoping central segment extending between first and second ends thereof;
a first drive element segment engaged with the drive subassembly, and extending over the corner portion from the drive subassembly;
a second drive element segment engaged with the support subassembly, and extending over the corner portion from the support subassembly; and
first and second universal joints, connecting the first and second ends of the central segment respectively with the first drive element segment and the second drive element segment.

17. A lane adjustment system according to claim 1 in which:
said at least one conveyor comprises a funnel portion thereof extending between upstream and downstream ends thereof; and
the lane guide elements define said at least one lane therebetween to have an upstream lane width at the upstream end that is greater than a downstream lane width thereof at the downstream end.

18. A lane adjustment system according to claim 8 in which:
said at least one conveyor comprises a transition portion between an upstream portion and a downstream portion of said at least one conveyor, the upstream and downstream portions being longitudinally nonaligned;
the lane guide elements are positioned to guide the containers from the upstream portion to the downstream portion.

19. A method of adjusting lane guide elements defining respective lanes therebetween for guiding containers moved by at least one conveyor in a preselected direction in the lanes, each said lane having a lane width transverse to the preselected direction, the method comprising:
(a) providing a plurality of cross-members positioned at least partially transverse to the preselected direction and positioned spaced apart from each other along said at least one conveyor; and
(b) providing at least one lane guide adjustor module secured to a selected one of the lane guide elements to define a selected one of the lanes and mounted to a selected one of the cross-members, said at least one lane adjustor module comprising a drive subassembly for moving the selected one of the lane guide elements a predetermined distance along the selected one of the cross-members, to change the lane width of the selected one of the lanes by the predetermined distance.

20. A method according to claim 19 additionally comprising:
(c) providing a drive element secured to the drive subassembly and rotatable thereby about a drive element axis of rotation in direct relation to linear motion of said at least one lane guide adjustor module over the predetermined distance along the selected one of the cross-members;
(d) providing at least one lane guide support module mounted on a selected support one of the cross-members comprising a support subassembly engaged with the selected support one of the cross-members and secured to the drive element, said at least one lane guide support module being secured to the selected one of the lane guide elements, the support subassembly being formed to convert rotational motion of the drive element to linear motion of said at least one lane guide support module over the predetermined distance along the selected support one of the cross-members, to change the lane width of the selected one of the lanes by the predetermined distance; and
(e) rotating the drive element about the drive element axis of rotation, to move said at least one lane guide adjustor module along the selected one of the cross-members by the predetermined distance, and to move said at least one lane guide support module along the selected support one of the cross-members by the predetermined distance to change the lane width of the selected one of the lanes by the predetermined distance.
